(19) United States
(12) Patent Application Publication
(10) Pub. No.: US 2026/0347700 A1
(43) Pub. Date: Nov. 5, 2026

(54) COMPOSITION FOR FORMING ELECTRO-OPTICAL LAYER, ELECTRO-OPTICAL LAYER, AND LAMINATE

(71) Applicant: FUJIFILM Corporation, Tokyo (JP)

(72) Inventors: Wataru HOSHINO, Minamiashigara-shi (JP); Hideyuki NAKAMURA, Minamiashigara-shi (JP)

(73) Assignee: FUJIFILM Corporation, Tokyo (JP)

(21) Appl. No.: 19/467,855

(22) Filed: Feb. 3, 2026

Related U.S. Application Data
(63) Continuation of application No. PCT/JP2024/029842, filed on Aug. 22, 2024.

(30) Foreign Application Priority Data
Sep. 4, 2023 (JP) 2023-143074

(51) Int. Cl. C09K 19/56; C09K 19/02; C09K 19/52

(52) U.S. Cl. CPC C09K 19/56; C09K 19/02; C09K 2019/528

(57) ABSTRACT

An object of the present invention is to provide a composition for forming an electro-optical layer, an electro-optical layer, and a laminate, which can form an electro-optical layer having a high electro-optical coefficient and a small transmission loss. The composition for forming an electro-optical layer of the present invention contains a liquid crystal compound, an organic coloring agent having a second-order molecular susceptibility of 400000×10⁻³³ esu or more, and a surfactant.

### CROSS-REFERENCE TO RELATED APPLICATIONS

This application is a Continuation of PCT International Application No. PCT/JP2024/029842 filed on Aug. 22, 2024, which claims priority under 35 U.S.C. § 119 (a) to Japanese Patent Application No. 2023-143074 filed on Sep. 4, 2023. The above applications are hereby expressly incorporated by reference, in their entirety, into the present application.

### BACKGROUND OF THE INVENTION

### 1. Field of the Invention

The present invention relates to a composition for forming an electro-optical layer, an electro-optical layer, and a laminate.

### 2. Description of the Related Art

In recent years, from the viewpoint of achieving ultra-high-speed optical communication, an organic electro-optical (hereinafter, also abbreviated as “EO”) material has been attracting attention as a material which can be applied to an optical control element (optical element) such as an optical modulator, an optical switch, and an optical interconnect.

For example, JP1990-029721A (JP-H2-029721A) discloses a nonlinear optical element obtained by subjecting a nonlinear optical material containing a polymer liquid crystal compound and a nonlinear optical compound to an alignment treatment, and discloses that the nonlinear optical material subjected to the alignment treatment is used as an electro-optical layer of an optical waveguide or the like.

### SUMMARY OF THE INVENTION

As a result of evaluating the electro-optical layer formed of the nonlinear optical material as disclosed in JP1990-029721A (JP-H2-029721A), the present inventors have found that an electro-optical coefficient of the electro-optical layer is low and a transmission loss of the electro-optical layer is large.

Therefore, an object of the present invention is to provide a composition for forming an electro-optical layer, an electro-optical layer, and a laminate, which can form an electro-optical layer having a high electro-optical coefficient and a small transmission loss.

As a result of intensive studies to achieve the above-described object, the present inventors have found that, by using a composition for forming an electro-optical layer, which contains a liquid crystal compound, an organic coloring agent having a predetermined second-order molecular susceptibility, and a surfactant, an electro-optical layer having a high electro-optical coefficient and a small transmission loss can be formed, and have completed the present invention.

That is, the present inventors have found that the above-described object can be achieved by employing the following configurations.

[1]

A composition for forming an electro-optical layer, comprising:
a liquid crystal compound;
an organic coloring agent having a second-order molecular susceptibility of 400000×10⁻³³ esu or more; and
a surfactant.
   [2]

The composition for forming an electro-optical layer according to [1],
in which an aspect ratio of a molecule of the organic coloring agent is 2.0 or more.
   [3]

The composition for forming an electro-optical layer according to [1] or [2],
in which an angle θeg formed by a vector of a molecular major axis and a vector of a transition dipole moment in the organic coloring agent is 10.0° or less.
   [4]

The composition for forming an electro-optical layer according to any one of [1] to [3],
in which the organic coloring agent is a compound represented by Formula (E1),

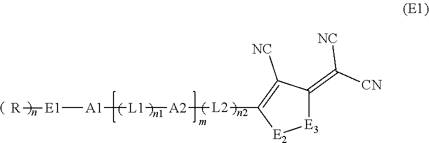

in Formula (E1),
R represents a hydrogen atom, or an alkyl group, an aryl group, or a heterocyclic group, which may have a substituent, in which —CH₂— in the alkyl group may be substituted with a divalent substituent, and in a case where n is 2 or more, two or more R's may be the same or different from each other, and may be bonded to each other to form a ring including E1,
E1 represents an oxygen atom, a sulfur atom, or a nitrogen atom,
A1 represents —C(R^{A1})═C(R^{A2})—, or an arylene group or a heterocyclic group, which may have a substituent,
R^{A1} and R^{A2} each independently represent a hydrogen atom, —SH, or an alkyl group, in which —CH₂— in the alkyl group may be substituted with a divalent substituent, and in a case where A1 is-C(R^{A1})═C(R^{A2})—, RAI and R may be bonded to each other to form a ring including E1,
A2 represents a single bond, or an arylene group or a heterocyclic group, which may have a substituent, in which, in a case where m is 2 or more, two or more A2's may be the same or different from each other,
L1 and L2 each independently represent a single bond, —C(R^{L1})═C(R^{L2})—, —N═C(R^{L4})—, —C(R^{L4})═N—, —C≡C—, or —N═N—, in which, in a case where n1 or m is 2 or more, two or more L1's may be the same or different from each other, in a case where n2 is 2 or more, two or more L2's may be the same or different from each other, in a case where n1 is 2 or more, adjacent L1's may be bonded to each other to form a ring, in a case where n2 is 2 or more, adjacent L2's may be bonded to each other to form a ring, and in a case where L1 and L2 are adjacent to each other, adjacent L1 and L2 may be bonded to each other to form a ring,
R^{L1}, R^{L2}, and R¹⁴ each independently represent a hydrogen atom, a halogen atom, a cyano group, a nitro group, a hydroxy group, a thiol group, an alkyl group having 1 to 15 carbon atoms, an aryl group having 6 to 20 carbon atoms, —O—Si(R^{L5})₃, or a group formed by combining two or more of these groups, in which-CH₂-in the alkyl group may be substituted with a divalent substituent, and a plurality of R^{L5}'s each independently represent a hydrogen atom, an alkyl group, or a phenyl group,
E₂ represents —C(R^{E21})(R^{E22})—, —C(═O)—, —C(═S)—, or —C(═NR^{E4})—,
R^{E21} and R^{E22} each independently represent a hydrogen atom, a halogen atom, an alkyl group having 1 to 15 carbon atoms, a fluoroalkyl group having 1 to 8 carbon atoms, an aryl group having 1 to 20 carbon atoms, a cyano group, or a nitro group, in which-CH₂-in the alkyl group may be substituted with a divalent substituent, and hydrogen atoms of the alkyl group and the aryl group may be substituted with a monovalent substituent,
R^{E4} represents a hydrogen atom or an alkyl group having 1 to 15 carbon atoms, in which-CH₂-in the alkyl group may be substituted with a divalent substituent,
E3 represents —O—, —S—, —N(R^{E5})—, or —S(═O)—,
R^{E5} represents a hydrogen atom, or an alkyl group having 1 to 15 carbon atoms, an aryl group having 5 to 20 carbon atoms, an alkylcarbonyl group having 1 to 15 carbon atoms, an arylcarbonyl group having 5 to 20 carbon atoms, an alkylsulfonyl group having 1 to 15 carbon atoms, or an arylsulfonyl group having 5 to 20 carbon atoms, which may have a substituent,
n represents an integer of 1 or 2,
n1 represents an integer of 0 to 3,
n2 represents an integer of 0 to 3, and
m represents an integer of 0 to 4.
   [5]

An electro-optical layer formed of the composition for forming an electro-optical layer according to any one of [1] to [4],
in which the organic coloring agent contained in the electro-optical layer is aligned.
   [6]

The electro-optical layer according to [5],
in which an alignment degree of the organic coloring agent is more than 0.3.
   [7]

A laminate comprising:
an alignment layer; and
the electro-optical layer according to [5] or [6], which is disposed on the alignment layer.

According to the present invention, it is possible to provide a composition for forming an electro-optical layer, an electro-optical layer, and a laminate, which can form an electro-optical layer having a high electro-optical coefficient and a small transmission loss.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

In the present specification, numerical ranges represented by “to” include numerical values before and after “to” as lower limit values and upper limit values.

In addition, in the present specification, parallel, orthogonal, horizontal, and vertical do not indicate parallel, orthogonal, horizontal, and vertical in a strict sense, but respectively indicate a range of parallel±10°, a range of orthogonal±10°, a range of horizontal±10°, and a range of vertical±10°.

In addition, in the present specification, substances corresponding to respective components may be used alone or in combination of two or more kinds thereof. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In addition, a bonding direction of divalent groups described in the present specification is not limited unless otherwise specified. For example, in a case where Y in a compound represented by Formula “X—Y—Z” is-C(O)—O—, Y may be—C(O)—O— or —O—C(O)—. In addition, the above-described compound may be “X—C(O)—O—Z” or “X—O—C(O)—Z”.

### [Substituent W]

A substituent W used in the present specification represents any of the following groups.

Examples of the substituent W include a halogen atom, an alkyl group having 1 to 20 carbon atoms, a halogenated alkyl group having 1 to 20 carbon atoms, a cycloalkyl group having 1 to 20 carbon atoms, an alkylcarbonyl group having 1 to 10 carbon atoms, an alkoxycarbonyl group having 1 to 10 carbon atoms, an alkylcarbonyloxy group having 1 to 10 carbon atoms, an alkylamino group having 1 to 10 carbon atoms, an alkylaminocarbonyl group, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (also referred to as a hetero ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), and other known substituents.

Details of the substituent are described in paragraph of JP2007-234651A.

In addition, the substituent W may be a group represented by Formula (W1).

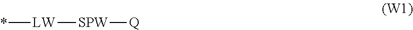

In Formula (W1), LW represents a single bond or a divalent linking group, SPW represents a divalent spacer group, Q represents a crosslinkable group, and * represents a bonding position.

Examples of the divalent linking group represented by LW include —O—, —(CH₂)_{g}—, (CF₂)_{g}—, —Si(CH₃)₂—, —(Si(CH₃)₂O)_{g}-(g represents an integer of 1 to 10), —N(Z)—, —C(Z)═C(Z′)—, —C(Z)═N—, —C(Z)₂—C(Z′)₂—, —C(O)—, —C(O)O—, —O—C(O)O—, —C(O)N(Z)—, —C(Z)═C(Z′)—C(O)O—, —C(Z)═C(Z′)—C(O)N(Z″)—, —C(Z)═C(Z′)—C(O)—S—, —C(Z)═N—N═C(Z′)—(Z, Z′, and Z″ each independently represent a hydrogen atom, an alkyl group having 1 to 4 carbon atoms, a cycloalkyl group, an aryl group, a cyano group, or a halogen atom), —C≡C—, —N═N—, —S—, —S(O)—, —S(O) (O)—, —(O) S(O)O—, —O(O) S(O)O—, and —SC(O)—. LW may be a group in which two or more of these groups are combined (hereinafter, also abbreviated as “L-C”).

Examples of the divalent spacer group represented by SPW include a linear, branched, or cyclic alkylene group having 1 to 50 carbon atoms, and a heterocyclic group having 1 to 20 carbon atoms.

The carbon atom of the alkylene group or the heterocyclic group described above may be substituted with —O—, —Si(CH₃)₂—, —(Si(CH₃)₂O)_{g}— (g represents an integer of 1 to 10), —N(Z)—, —C(Z)═C(Z′)—, —C(Z)═N—, —C(Z)₂—C(Z′)₂—, —C(O)—, —C(O)O—, —O—C(O)O—, —C(O)N(Z)—, —C(Z)═C(Z′)—C(O)O—, —C(Z)═C(Z′)—C(O)N(Z″)—, —C(Z)═C(Z′)—C(O)—S—, —C(Z)═N—N═C(Z′)—(Z, Z′, and Z″ each independently represent a hydrogen atom, an alkyl group having 1 to 4 carbon atoms, a cycloalkyl group, an aryl group, a cyano group, or a halogen atom), —C≡C—, —N═N—, —S—, —C(S)—, —S(O)—, —SO₂—, —(O) S(O)O—, —O(O) S(O)O—, —SC(O)—, or a group in which two or more of these groups are combined (hereinafter, also abbreviated as “SP—C”).

The hydrogen atom of the above-described alkylene group or the hydrogen atom of the heterocyclic group may be substituted with a halogen atom, a cyano group, —Z^{H}, —OH, —OZ^{H}, —COOH, —C(O)Z^{H}, —C(O)OZ^{H}, —OC(O)Z^{H}, —OC(O)OZ^{H}, —NZ^{H}Z^{H′}, —NZ^{H}C(O)Z^{H′}, —NZ^{H}C(O)OZ^{H′}, —C(O)NZ^{H}Z^{H′}, —OC(O)NZ^{H}Z^{H′}, —NZ^{H}C(O)NZ^{H′}OZ^{H}″, —SH, —SZ^{H}, —C(S) Z^{H}, —C(O) SZ^{H}, or —SC(O)Z^{H} (hereinafter, also abbreviated as “SP—H”). Here, Z^{H}, Z^{H′}, and Z^{H″} each independently represent an alkyl group having 1 to 10 carbon atoms, a halogenated alkyl group, or -L-CL.

In -L-CL, L represents a single bond or a divalent linking group. Specific examples of the divalent linking group are the same as those for LW and SPW described above.

In -L-CL, CL represents a crosslinkable group. Specific examples of the crosslinkable group include crosslinkable groups represented by Formulae (P-1) to (P-30).

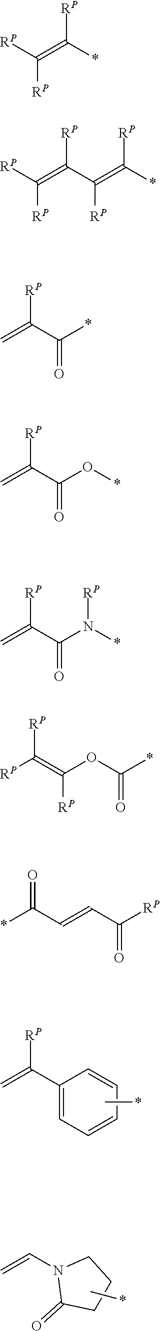

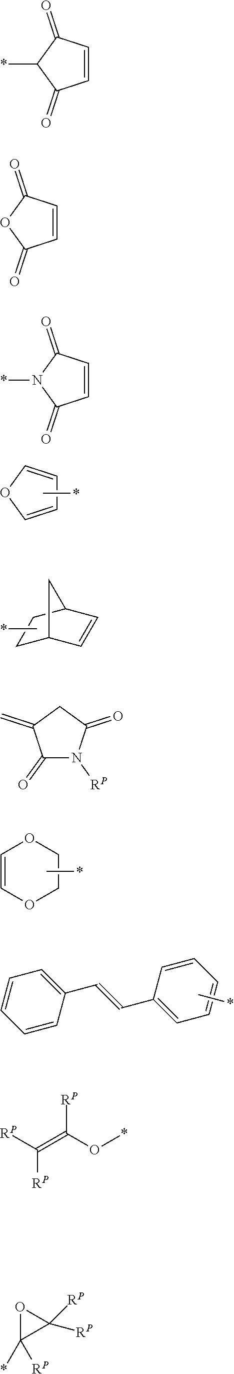

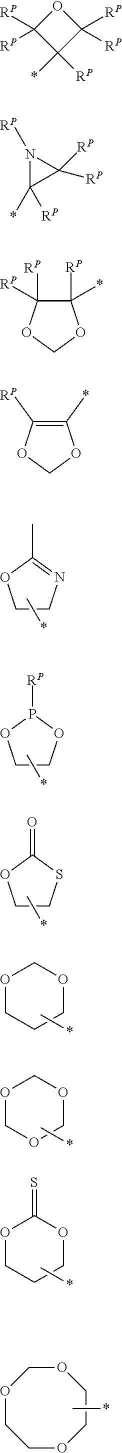

In Formulae (P-1) to (P-30), RP represents a hydrogen atom, a halogen atom, a linear, branched, or cyclic alkylene group having 1 to 10 carbon atoms, a halogenated alkyl group having 1 to 20 carbon atoms, an alkoxy group having 1 to 20 carbon atoms, an alkenyl group having 2 to 20 carbon atoms, an alkynyl group having 2 to 20 carbon atoms, an aryl group having 6 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), or a sulfate group (—OSO₃H); and a plurality of RP's may be the same or different from each other.

### [Composition for Forming Electro-Optical Layer]

The composition for forming an electro-optical layer according to the embodiment of the present invention (hereinafter, also referred to as “present composition”) contains a liquid crystal compound, an organic coloring agent having a second-order molecular susceptibility of 400000×10⁻³³ esu or more (hereinafter, also referred to as “specific organic coloring agent”), and a surfactant.

With the present composition, an electro-optical layer (hereinafter, also referred to as an “EO layer”) having a high electro-optical coefficient and a small transmission loss can be formed. The details of the reason for this are not clear, but it is presumed as follows.

It is presumed that the electro-optical coefficient of the EO layer formed of the present composition is high because the specific organic coloring agent contained in the present composition has a high second-order molecular susceptibility.

In addition, it is presumed that surface unevenness of the EO layer formed of the present composition is reduced by an action of the surfactant contained in the present composition, and scattering of light is suppressed, so that the transmission loss in the EO layer can be reduced.

### [Liquid Crystal Compound]

The present composition contains a liquid crystal compound.

As the liquid crystal compound, both a high-molecular-weight liquid crystal compound and a low-molecular-weight liquid crystal compound can be used, and from the viewpoint of increasing an alignment degree, a high-molecular-weight liquid crystal compound is preferable. In addition, the high-molecular-weight liquid crystal compound and the low-molecular-weight liquid crystal compound may be used in combination as the liquid crystal compound.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the high-molecular-weight liquid crystal compound include thermotropic liquid crystalline polymers described in JP2011-237513A and high-molecular-weight liquid crystal compounds described in paragraphs to of WO2018/199096A.

Examples of the low-molecular-weight liquid crystal compound include liquid crystal compounds described in paragraphs to of JP2013-228706A, and among these, a liquid crystal compound exhibiting smectic properties is preferable.

Examples of such a liquid crystal compound include compounds described in paragraphs to of WO2022/014340A, the description of which is incorporated herein by reference.

From the viewpoint of being able to further increase the alignment degree, a side-chain type high-molecular-weight liquid crystal compound is preferable as the high-molecular-weight liquid crystal compound. The side-chain type high-molecular-weight liquid crystal compound is a liquid crystal compound having a repeating unit.

Suitable examples of the side-chain type high-molecular-weight liquid crystal compound include a liquid crystal compound having a repeating unit represented by Formula (1), described in paragraph of WO2018/199096A.

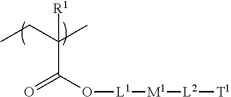

In Formula (1), R¹ represents a hydrogen atom or a methyl group, L¹ and L² each independently represent a single bond or a divalent linking group, M¹ represents a mesogenic group represented by Formula (1-1) described later, and T¹ represents a terminal group.

In addition, suitable examples of the low-molecular-weight liquid crystal compound include a compound represented by Formula (2), described in paragraph of JP2013-228706A.

U¹—V¹—W¹—X¹—Y¹—X²—Y²—X³—W²—V²—U² (2)

In Formula (2),
X¹, X², and X³ each independently represent a 1,4-phenylene group which may have a substituent or a cyclohexane-1,4-diyl group which may have a substituent, at least one of X¹, X², or X³ represents a 1,4-phenylene group which may have a substituent, —CH₂-constituting the cyclohexane-1,4-diyl group which may have a substituent may be substituted with —O—, —S—, or —NR—, R represents an alkyl group having 1 to 6 carbon atoms or a phenyl group,
Y¹ and Y² each independently represent —CH₂CH₂—, —CH₂O—, —COO—, —OCOO—, a single bond, —N═N—, —CR^{a}═CR^{b}—, —C≡C—, or —CR^{a}═N—, R^{a} and R^{b} each independently represent a hydrogen atom or an alkyl group having 1 to 4 carbon atoms,
U¹ represents a hydrogen atom or a polymerizable group,
U² represents a polymerizable group,
W¹ and W² each independently represent a single bond, —O—, —S—, —COO—, or —OCOO—, and
V¹ and V² each independently represent an alkanediyl group having 1 to 20 carbon atoms, which may have a substituent, where —CH₂— constituting the alkanediyl group may be substituted with —O—, —S—, or —NH—.

From the viewpoint of increasing the alignment degree, the liquid crystal compound preferably has at least one group selected from the group consisting of a fluorine atom, a cyano group, a trifluoromethyl group, and a nitro group.

A content of the liquid crystal compound is preferably 40 to 95 parts by mass and more preferably 50 to 90 parts by mass with respect to 100 parts by mass of the specific organic coloring agent.

From the viewpoint that the effect of the present invention is more excellent, a weight-average molecular weight (Mw) of the high-molecular-weight liquid crystal compound is preferably 1000 to 500,000 and more preferably 2,000 to 300,000. In a case where the Mw of the high-molecular-weight liquid crystalline compound is within the above-described range, the high-molecular-weight liquid crystalline compound is easily handled.

In particular, from the viewpoint of suppressing cracking during coating, the weight-average molecular weight (Mw) of the high-molecular-weight liquid crystalline compound is preferably 10,000 or more and more preferably 10,000 to 300,000.

In addition, from the viewpoint of temperature latitude of the alignment degree, the weight-average molecular weight (Mw) of the high-molecular-weight liquid crystalline compound is preferably less than 100,000 and preferably 2,000 or more and less than 100,000.

Here, the weight-average molecular weight of the high-molecular-weight liquid crystal compound is a value measured by a gel permeation chromatography (GPC) method.
Solvent (eluant): N-methylpyrrolidone
Device name: TOSOH HLC-8220GPC
Column: using three columns of TOSOH TSKgel Super AWM-H (6 mm×15 cm) connected
Column temperature: 25° C.
Sample concentration: 0.1% by mass
Flow rate: 0.35 mL/min.

Calibration curve: TSK standard polystyrene (manufactured by TOSOH Corporation), calibration curves of 7 samples with Mw of 2,800,000 to 1,050 (Mw/Mn=1.03 to 1.06) are used

### [Specific Organic Coloring Agent]

The present composition contains a specific organic coloring agent.

The second-order molecular susceptibility of the specific organic coloring agent is 400000×10⁻³³ esu or more, and from the viewpoint that the electro-optical coefficient is more excellent, it is preferably 1000000×10⁻³³ esu or more, more preferably 2000000×10⁻³³ esu or more, and still more preferably 3000000×10⁻³³ esu or more.

From the viewpoint of stability of the coloring agent, the second-order molecular susceptibility of the specific organic coloring agent is preferably 30000000×10⁻³³ esu or less, more preferably 25000000×10⁻³³ esu or less, and still more preferably 20000000×10⁻³³ esu or less.

Here, the second-order molecular susceptibility of the specific organic coloring agent refers to a value calculated by a density functional method under the following conditions using a quantum science calculation program Gaussian 16.
Functional: M06x02
Basic function: 6-31+g (d,p)
Solvent effect: chloroform
Other conditions: default value of Gaussian 16

From the viewpoint of further improving the alignment degree, the specific organic coloring agent is preferably a compound represented by Formula (E1).

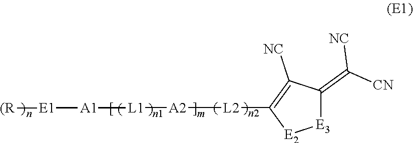

In Formula (E1), R represents a hydrogen atom, or an alkyl group, an aryl group, or a heterocyclic group, which may have a substituent.

Examples of the alkyl group in R include a linear alkyl group having 1 to 20 carbon atoms (preferably having 1 to 10 carbon atoms) and a branched or cyclic alkyl group having 1 to 20 carbon atoms (preferably having 1 to 10 carbon atoms). —CH₂— in the alkyl group may be substituted with a divalent substituent; and specific examples of the divalent substituent include L-C described above, and among the above, —C(O)O— is preferable.

Examples of the aryl group in R include an aryl group having 6 to 15 carbon atoms. Specific examples thereof include a phenyl group and a naphthyl group.

The heterocyclic group in R may be aromatic or non-aromatic. Examples of an atom other than carbon, constituting the heterocyclic group in R, include a nitrogen atom, a sulfur atom, and an oxygen atom; and in a case where the heterocyclic group has a plurality of atoms other than carbon in a ring, these atoms may be the same or different from each other. Specific examples of the heterocyclic group in R include a piperidinyl group, a piperazinyl group, a morpholinyl group, a pyrrolidinyl group, a pyrrolyl group, a pyrazolyl group, an indolyl group, an isoindolyl group, an azaindolyl group, a benzothiazolyl group, and a julolidinyl group.

Examples of the substituent which can be included in the alkyl group, the aryl group, and the heterocyclic group in R include SP—H described above, and among the above, —Z^{H}, —OH, —OZ^{H}, —OC(O)Z^{H}, —OC(O)OZ^{H}, —NZ^{H}Z^{H′}, —NZ^{H}C(O)Z^{H′}, —NZ^{H}C(O)OZ^{H′}, —NZ^{H}C(O)NZ^{H′}OZ^{H″}, —SH, or —SZ^{H} is preferable. Here, the definitions of Z^{H}, Z^{H′}, and Z^{H″} are as described above.

In a case where n is 2 or more, two or more R's may be the same or different from each other, and may be bonded to each other to form a ring including E1 (that is, a ring including E1 as a ring member atom). Specific examples of the ring including E1 include a piperidinyl group, a piperazinyl group, a morpholinyl group, a pyrrolidinyl group, a pyrrolyl group, a pyrazolyl group, an indolyl group, an isoindolyl group, an azaindolyl group, a benzothiazolyl group, and a julolidinyl group. The ring including E1 may have a substituent, and examples of the substituent include a hydroxy group.

In Formula (E1), E1 represents an oxygen atom, a sulfur atom, or a nitrogen atom, and from the viewpoint of a high electro-optical coefficient and synthetic suitability, a nitrogen atom is preferable.

In Formula (E1), A1 represents —C(R^{A1})═C(R^{A2})—, an arylene group which may have a substituent, or a heterocyclic group which may have a substituent.

Examples of the arylene group in A1 include an arylene group having 6 to 15 carbon atoms. Specific examples thereof include a phenylene group and a naphthylene group.

The heterocyclic group in A1 may be aromatic or non-aromatic, but is preferably an aromatic heterocyclic group. Examples of an atom other than carbon, constituting the heterocyclic group in A1, include a nitrogen atom, a sulfur atom, and an oxygen atom; and in a case where the heterocyclic group has a plurality of atoms other than carbon in a ring, these atoms may be the same or different from each other. Specific examples of the heterocyclic group in A1 include a pyridylene group (pyridine-diyl group), a pyridazine-diyl group, an imidazole-diyl group, thienylene (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimide-diyl group, a thienothiazole-diyl group, a thiazolothiazole-diyl group, a thienothiophene-diyl group, a thienooxazole-diyl group, a furan-diyl group, a dibenzofuran-diyl group, and a pyrazole-diyl group.

Examples of the substituent which can be included in the arylene group and the heterocyclic group in A1 include SP—H described above, and among the above, —Z^{H}, —OH, —OZ^{H}, —NZ^{H}Z^{H′}, —SH, or —SZ^{H} is preferable. Here, the definitions of Z^{H} and Z^{H′} are as described above.

In —C(R^{A1})═C(R^{A2})— of A1, R^{A1} and R^{A2} each independently represent a hydrogen atom, —SH, or an alkyl group, in which —CH₂— in the alkyl group may be substituted with a divalent substituent.

Examples of the alkyl group in R^{A1} and R^{A2} include a linear alkyl group having 1 to 20 carbon atoms (preferably having 1 to 10 carbon atoms) and a branched or cyclic alkyl group having 1 to 20 carbon atoms (preferably having 1 to 10 carbon atoms). —CH₂-in the alkyl group may be substituted with a divalent substituent; and specific examples of the divalent substituent include L-C described above, and among the above, —O—, —(CH₂)_{g}— (g represents an integer of 1 to 10), —N(Z)—, —C(Z)₂—C(Z′)₂—, —C(O)—, —C(O)O—, —O—C(O)O—, —C(O)N(Z)—, —S—, —S(O)—, —S(O) (O)—, or —(O) S(O)O— is preferable. The definitions of Z and Z′ are as described above.

Here, in a case where A1 is-C(R^{A1})—C(R^{A2})—, R^{A1} and R may be bonded to each other to form a ring including E1.

In addition, (R)ₙ-E1-A1- may form a fused ring. For example, in a case where A1 is —C(SH)—CH—, E1 is N, and one of two R's is a phenyl group, a sulfur atom of the—SH group is bonded to a carbon atom of the phenyl group to form a fused ring having a benzothiazole structure as shown below.

In the following formula, the definition of R is as described above, and * represents a bonding position to L¹ in Formula (E1).

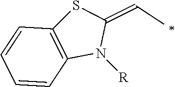

In Formula (E1), A2 represents a single bond, or an arylene group or a heterocyclic group, which may have a substituent. In a case where m is 2 or more, two or more A2's may be the same or different from each other.

Specific examples of the arylene group and the heterocyclic group in A2 are the same as those in A1.

In Formula (E1), L¹ and L² each independently represent a single bond, —C(R^{L1})—C(R^{L2})—, —N═C(R^{L4})—, —C(R^{L4})—N—, —C≡C—, or —N═N—.
R^{L1}, R^{L2}, and R^{L4} each independently represent a hydrogen atom, a halogen atom, a cyano group, a nitro group, a hydroxy group, a thiol group, an alkyl group having 1 to 15 carbon atoms, an aryl group having 6 to 20 carbon atoms, —O—Si(R^{L5})₃, or a group formed by combining two or more of these groups, in which-CH₂-in the alkyl group may be substituted with a divalent substituent. A plurality of R^{L5}'s each independently represent a hydrogen atom, an alkyl group (preferably having 1 to 10 carbon atoms; it may be linear, branched, or cyclic), or a phenyl group.

In a case where n1 is 2 or more, adjacent L1's may be bonded to each other to form a ring; in a case where n2 is 2 or more, adjacent L2's may be bonded to each other to form a ring; and in a case where L1 and L2 are adjacent to each other (that is, in a case where A2 is a single bond), adjacent L1 and L2 may be bonded to each other to form a ring. For example, in a case where both of two adjacent L1's are—C(R^{L1})—C(R^{L2})—, R^{L1} in one L1 and R^{L1} in the other L1 may be bonded to each other to form a ring having the following structure (in the formula, * represents a bonding site to another group). In a case where L1 and L2 are adjacent to each other and in a case where L2's are adjacent to each other, the same ring having the following structure as in the case where L1's are linked to each other can be formed.

In a case where n1 or m is 2 or more, two or more L1's may be the same or different from each other; and in a case where n2 is 2 or more, two or more L2's may be the same or different from each other.

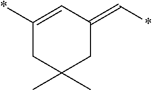

In Formula (E1), E₂ represents —C(R^{E21})(R^{E22})—, —C(═O)—, —C(═S)—, or —C(═NR^{E4})—.
R^{E21} and R^{E22} each independently represent a hydrogen atom, a halogen atom, an alkyl group having 1 to 15 carbon atoms, a fluoroalkyl group having 1 to 8 carbon atoms, an aryl group having 1 to 20 carbon atoms, a cyano group, or a nitro group.
—CH₂— in the alkyl group of R^{E21} and R^{E22} may be substituted with a divalent substituent, and a hydrogen atom of the alkyl group and the aryl group may be substituted with a monovalent substituent. Specific examples of the divalent substituent include SP—C described above, and among the above, —O—, —C(Z)═N—, —C(O)—, —C(O)O—, —C(O)N(Z)—, —C(S)—, —S(O)—, —SO₂—, —(O)S(O)O—, —O(O)S(O)O—, or —SC(O)— is preferable. Examples of the monovalent substituent include SP—H described above, and among the above, a halogen atom (particularly a fluorine atom or a chlorine atom), a cyano group, —Z^{H}, —OH, —OZ^{H}, —C(O)Z^{H}, —C(O)OZ^{H}, —OC(O)Z^{H}, —OC(O)OZ^{H}, —NZ^{H}Z^{H}′, —NZ^{H}C(O)Z^{H}′, —NZ^{H}C(O)OZ^{H}′, —C(O)NZ^{H}Z^{H}′, —OC(O)NZ^{H}Z^{H}′, —NZ^{H}C(O)NZ^{H}′OZ^{H}″, —C(S)Z^{H}, —C(O)SZ^{H}, or —SC(O)Z^{H} is preferable. Here, the definitions of Z^{H}, Z^{H}′, and Z^{H}″ are as described above.
R^{E4} represents a hydrogen atom or an alkyl group having 1 to 15 carbon atoms, in which —CH₂— in the alkyl group may be substituted with a divalent substituent. Specific examples of the divalent substituent include SP—C described above, and among the above, —O—, —(CH₂)_{g}—, —N(Z)—, —C(Z)₂—C(Z′)₂—, —C(O)—, —C(O)O—, —O—C(O)O—, —C(O)N(Z)—(Z and Z′ each independently represent a hydrogen atom, an alkyl group having 1 to 4 carbon atoms, a cycloalkyl group, an aryl group, a cyano group, or a halogen atom), —S—, —S(O)—, —S(O)(O)—, —(O)S(O)O—, —O(O)S(O)O—, or —SC(O)— is preferable.

In Formula (E1), E₃ represents —O—, —S—, —N(R^{E5})—, or —S(═O)—.
R^{E5} represents a hydrogen atom, or an alkyl group having 1 to 15 carbon atoms, an aryl group having 5 to 20 carbon atoms, an alkylcarbonyl group having 1 to 15 carbon atoms, an arylcarbonyl group having 5 to 20 carbon atoms, an alkylsulfonyl group having 1 to 15 carbon atoms, or an arylsulfonyl group having 5 to 20 carbon atoms, which may have a substituent. Specific examples of the substituent include SP—H described above, and among the above, —Z^{H}, —C(O)Z^{H}, —C(O)OZ^{H}, —C(O)NZ^{H}Z^{H}′, —C(S)Z^{H}, or —C(O)SZ^{H} is preferable. Here, the definitions of Z^{H} and Z^{H}′ are as described above.

In Formula (E1), n represents an integer of 1 or 2. In a case where E1 is an oxygen atom or a sulfur atom, n is 1; and in a case where E1 is a nitrogen atom, n is 2.

In Formula (E1), n1 represents an integer of 0 to 3, and is preferably an integer of 0 to 2.

In Formula (E1), n2 represents an integer of 0 to 3, and is preferably an integer of 0 to 3.

In Formula (E1), m represents an integer of 0 to 4, and is preferably an integer of 1 to 3.

From the viewpoint that the effect of the present invention is more excellent, the compound represented by Formula (E1) is preferably a compound represented by Formula (E1-1) or a compound represented by Formula (E1-2), and more preferably a compound represented by Formula (E1-1).

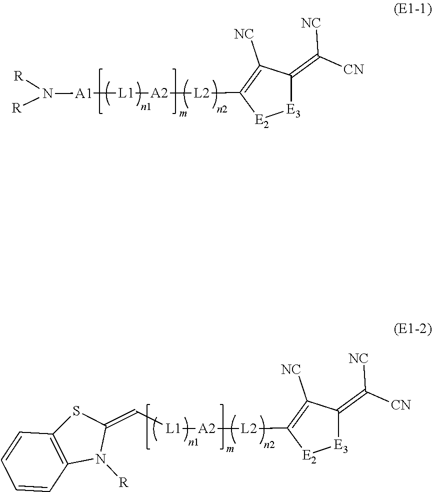

The definitions of each group in Formulae (E1-1) and (E1-2) are the same as those in Formula (E1).

Specific examples of the specific organic coloring agent are shown below, but the specific organic coloring agent is not limited thereto.

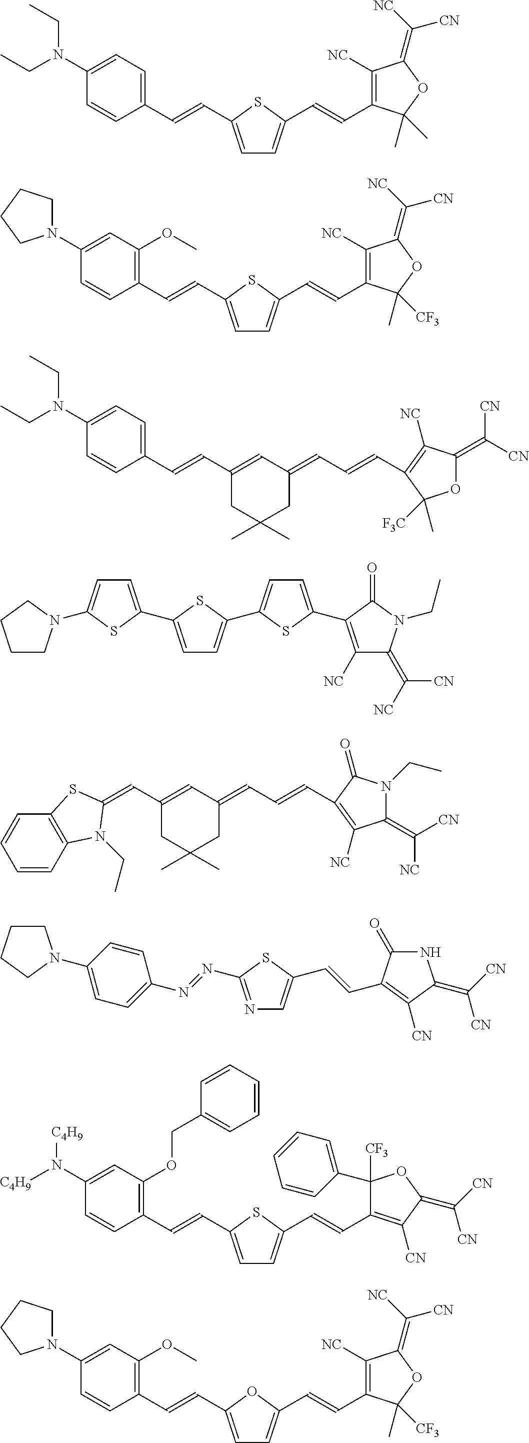

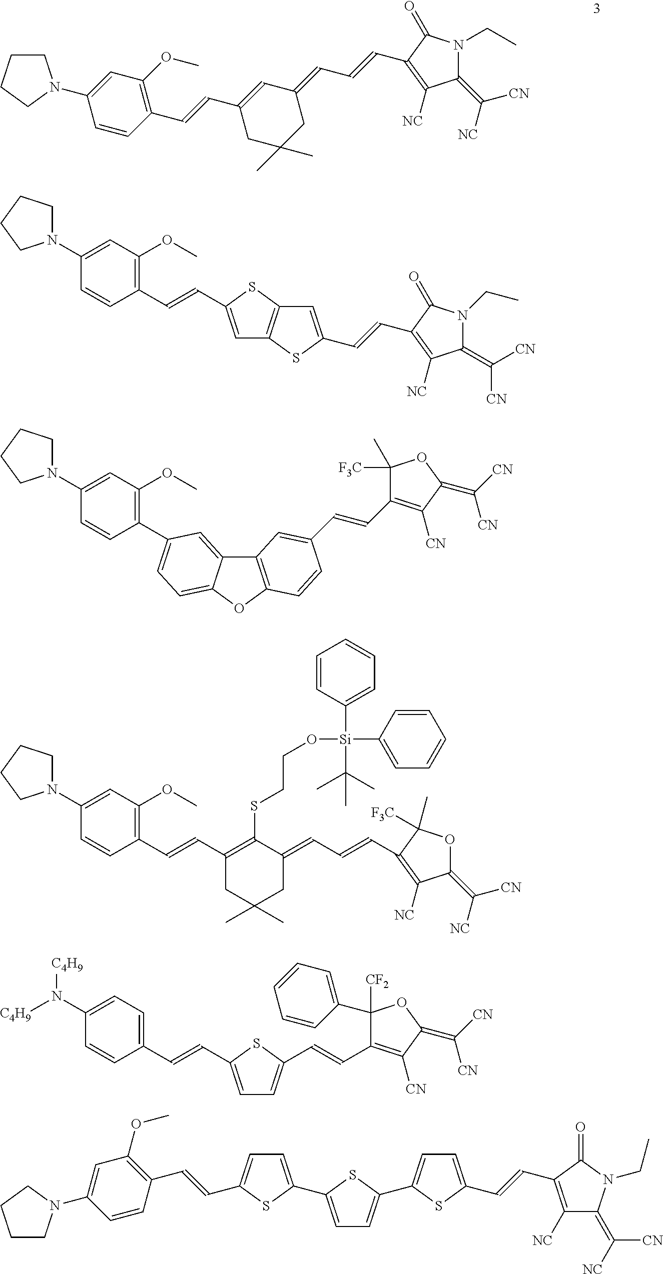

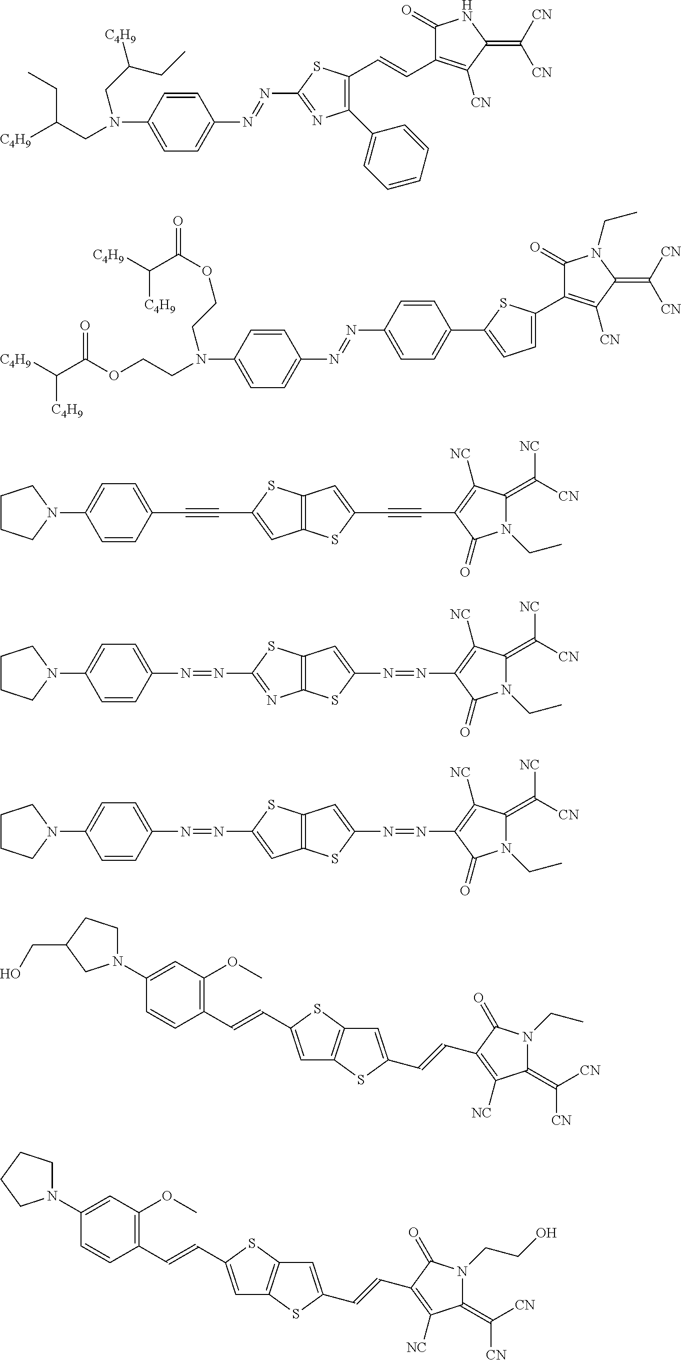

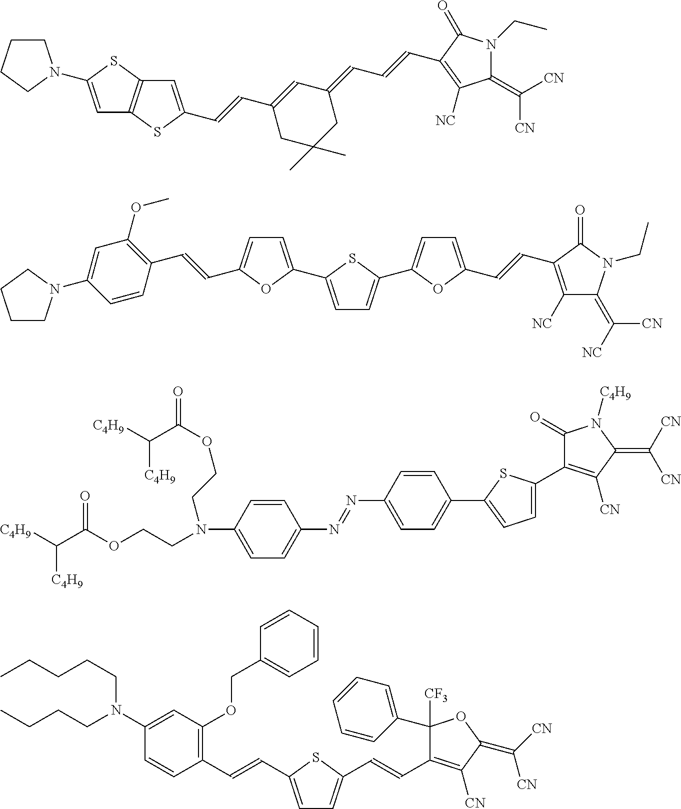

From the viewpoint of further improving the alignment degree of the specific organic coloring agent, an aspect ratio of the molecule of the specific organic coloring agent is preferably 1.6 or more, more preferably 2.0 or more, still more preferably 2.2 or more, and particularly preferably 2.3 or more.

From the viewpoint of synthetic suitability and alignment degree, the aspect ratio of the molecule of the specific organic coloring agent is preferably 5.0 or less, more preferably 4.0 or less, and still more preferably 3.5 or less.

The aspect ratio of the molecule of the specific organic coloring agent means a ratio (L/D) of a length (L) to a diameter (D) of a cylinder having the smallest diameter in which the molecule of the specific organic coloring agent is inscribed, and as the aspect ratio is larger, the molecular shape is more elongated.

The aspect ratio of the molecule of the specific organic coloring agent is calculated using Winmostar V11.4.3 (manufactured by X-Ability Co., Ltd.) which is simulation software under the following conditions, after determining the most stable stereostructure of the specific organic coloring agent.
Hamiltonian: AM1
Method: EF
MM: MMOK
GNORM: 0.05

From the viewpoint of further improving the alignment degree of the specific organic coloring agent, the length (L) of the above-described cylinder is preferably 15.0 to 50.0 Å, more preferably 18.0 to 41.0 Å, and still more preferably 21.0 to 38.0 Å.

From the viewpoint of further improving the alignment degree of the specific organic coloring agent, the above-described diameter (D) is preferably 5.0 to 16.5 Å, more preferably 5.5 to 14.5 Å, and still more preferably 6.5 to 13.5 Å.

As a method of increasing the aspect ratio of the molecule of the specific organic coloring agent, it is preferable that a substituent in a minor axis direction, for example, the substituents of A1 and A2, R^{L1} to R^{L4}, R^{E21}, R^{E22}, and R^{E4} in Formula (E1) is a group having a linear structure or a group having a branched structure and having 10 or less atoms (here, the number of atoms does not include the number of hydrogen atoms). In addition, it is also preferable that the above-described substituent is not a ring structure.

From the viewpoint of further improving the alignment degree of the specific organic coloring agent, an angle θeg formed by a vector of a molecular major axis and a vector of a transition dipole moment in the organic coloring agent is preferably 10.0° or less, more preferably 8.0° or less, and still more preferably 6.0° or less.

The lower limit value of θeg is 0°.

θeg is calculated as an angle formed by a vector of a molecular major axis and a vector of a transition dipole moment in the most stable stereostructure using Winmostar V11.4.3 (manufactured by X-Ability Co., Ltd.) which is simulation software under the same conditions as the aspect ratio described above, after determining the most stable stereostructure of the specific organic coloring agent. In a case where a plurality of transition dipole moments are present, a vector of the transition dipole moment having the maximum absorption wavelength is used for the calculation of θeg. In addition, in a case where the calculated angle exceeds 90°, the calculated angle is subtracted from 1800 to be adjusted to a range of 0° or more and less than 90°, and this value is defined as θeg.

Specific examples of a method of adjusting θeg within the above-described range include a method of introducing, as the substituents of A1 and A2, R^{L1} to R^{L4}, R^{E21}, R^{E22}, and R^{E4} in Formula (E1), a group which is not a strong electron-donating group or an electron-withdrawing group.

A content of the specific organic coloring agent is preferably 1% to 80% by mass, more preferably 2% to 70% by mass, and still more preferably 4% to 60% by mass with respect to the total mass of the liquid crystal composition.

In a case where the content of the specific organic coloring agent is 1% by mass or more, the electro-optical coefficient is further improved. In addition, in a case where the content of the specific organic coloring agent is 80% by mass or less, the alignment degree of the specific organic coloring agent is more excellent.

### [Surfactant]

The present composition contains a surfactant. As described above, by containing the surfactant, the present composition can reduce the transmission loss. In addition, as a result of the action of the surfactant, aligning properties of the liquid crystal compound in the EO layer are improved, so that the alignment degree of the specific organic coloring agent aligned along the liquid crystal compound can be increased.

As the surfactant, a low-molecular-weight surfactant or a high-molecular-weight surfactant can be used. In addition, as the surfactant, the high-molecular-weight surfactant and the low-molecular-weight surfactant may be used in combination.

Here, the “high-molecular-weight surfactant” refers to a surfactant having a repeating unit in the chemical structure.

In addition, the “low-molecular-weight surfactant” refers to a surfactant having no repeating unit in the chemical structure.

From the viewpoint of more excellent effect of reducing the transmission loss and further improving the alignment degree, as the high-molecular-weight surfactant, it is preferable to have one or more repeating units (constitutional units) selected from the group consisting of a repeating unit represented by Formula (F-1), a repeating unit represented by Formula (F-2), a repeating unit represented by Formula (S-1), a repeating unit represented by Formula (A-1), and a repeating unit represented by Formula (M-1).

Among these, from the viewpoint of further excellent effect of reducing the transmission loss and further improving the alignment degree, it is more preferable to have both one or more repeating units selected from the group consisting of a repeating unit represented by Formula (F-1), a repeating unit represented by Formula (F-2), a repeating unit represented by Formula (S), and a repeating unit represented by Formula (A) (hereinafter, also referred to as “first constitutional unit”), and a repeating unit represented by Formula (M) (hereinafter, also referred to as “second constitutional unit”).

### <First Constitutional Unit>

### (Repeating Unit F-1)

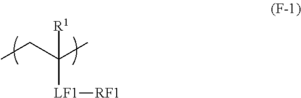

In Formula (F-1), LF1 represents a single bond or a divalent linking group,
R¹ represents a hydrogen atom, a fluorine atom, a chlorine atom, or an alkyl group having 1 to 20 carbon atoms, and
RF1 represents a group including at least one of
(a) a group represented by Formula (1), (2), or (3),
(b) a perfluoropolyether group, or
(d) a group represented by Formula (1-d).

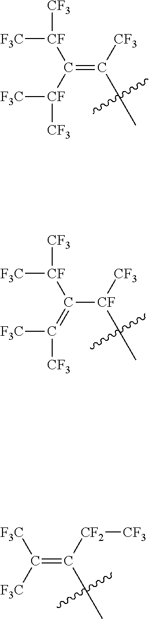

In Formula (F-1), R1 preferably represents a hydrogen atom, a fluorine atom, or an alkyl group having 1 to 4 carbon atoms, and more preferably represents a hydrogen atom or a methyl group.

In Formula (F-1), LF1 represents a single bond or a divalent linking group; and more specific examples thereof include a group represented by -LW-SPW— in Formula (W1) described above, an aromatic hydrocarbon group having 4 to 20 carbon atoms, a cyclic alkylene group having 4 to 20 carbon atoms, and a heterocyclic group having 1 to 20 carbon atoms, and among these, LF1 is preferably a linear, branched, or cyclic alkylene group having 1 to 20 carbon atoms or an aromatic hydrocarbon group having 4 to 20 carbon atoms, and preferably includes —O—, —C(O)—O—, —C(O)—NH—, or —O—C(O)—.

### (a) Repeating Unit Having Group Represented by Formula (1), (2), or (3)

In a case where RF1 of Formula (F-1) includes a group represented by Formula (1), (2), or (3), it is also preferable that Formula (F-1) is a repeating unit represented by Formula (4).

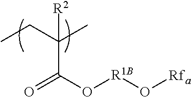

In Formula (4), Rfₐ is the group represented by Formula (1), (2), or (3).

In Formula (4), R^{1B} is a divalent group having 2 to 50 carbon atoms. The divalent group having 2 to 50 carbon atoms, represented by R^{1B}, may include a heteroatom and may be an aromatic group, a heteroaromatic group, a heterocyclic group, an aliphatic group, or an alicyclic group.

Specific examples of R^{1B} include the following groups.
—(CH₂)ₙ₁— (n1=2 to 50)
—X—Y—(CH₂)ₙ₂— (n2=2 to 43)
—X—(CH₂)ₙ₃— (n3=1 to 44)
—CH₂CH₂(OCH₂CH₂)ₙ₄— (n4=1 to 24)
—XCO(OCH₂CH₂)ₙ₅— (n5=1 to 21)

In the above-described formulae, X represents phenylene, biphenylene, or naphthylene, which may have one to three substituents selected from the group consisting of an alkyl group having 1 to 3 carbon atoms (a methyl group, an ethyl group, or a propyl group), an alkoxy group having 1 to 4 carbon atoms (a methoxy group, an ethoxy group, a propoxy group, a butoxy group, or the like), and a halogen atom (F, Cl, Br, or I). Y represents —O—CO—, —CO—O—, —CONH—, or —NHCO—.
X preferably represents 1,2-phenylene, 1,3-phenylene, or 1,4-phenylene, and more preferably represents 1,4-phenylene.

Specific examples of a particularly preferred divalent group having 2 to 50 carbon atoms, represented by R^{1B}, include divalent groups having the following structures.
—(CH₂)ₙ₁— (n1=2 to 10)
—C₆H₄OCO(CH₂)ₙ₂— (n2=2 to 10)
—C₆H₄(CH₂)ₙ₃— (n3=1 to 10)
—CH₂CH₂(OCH₂CH₂)ₙ₄— (n4=1 to 10)
—C₆H₄CO(OCH₂CH₂)ₙ₅— (n5=1 to 10)

In Formula (4), R² represents a hydrogen atom or a methyl group.

### (b) Repeating Unit Having Perfluoropolyether Group

In Formula (F-1), it is also preferable that RF1 has a perfluoropolyether group.

The perfluoropolyether group is a divalent group in which a plurality of fluorocarbon groups are bonded to each other through an ether bond. It is preferable that the perfluoropolyether group is a divalent group in which a plurality of perfluoroalkylene groups are bonded to each other through an ether bond.

The perfluoropolyether group may have a linear structure, a branched structure, or a cyclic structure, and preferably have a linear structure or a branched structure and more preferably have a linear structure.

In a case where RF1 of Formula (F-1) includes the repeating unit containing a perfluoropolyether group, it is preferable that Formula (F-1) is a constitutional unit represented by Formula (I-b).

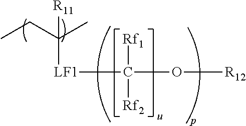

In Formula (I-b), LF1 represents the same group as in Formula (F-1), R₁₁ represents a hydrogen atom, a fluorine atom, a chlorine atom, or an alkyl group having 1 to 20 carbon atoms, Rf₁ and Rf₂ each independently represent a fluorine atom or a perfluoroalkyl group, in a case where a plurality of Rf₁'s are present, the plurality of Rf₁'s may be the same or different from each other, in a case where a plurality of Rf₂'s are present, the plurality of Rf₂'s may be the same or different from each other, u represents an integer of 1 or more, and p represents an integer of 1 or more.

R₁₂ represents a hydrogen atom or a substituent, and the substituent is not particularly limited, but examples thereof include a fluorine atom, a perfluoroalkyl group (preferably having 1 to 10 carbon atoms), an alkyl group (preferably having 1 to 10 carbon atoms), and a hydroxyalkyl group (preferably having 1 to 10 carbon atoms).

In Formula (I-b), u represents an integer of 1 or more, preferably 1 to 10, more preferably 1 to 6, and still more preferably 1 to 3.

In Formula (I-b), p represents an integer of 1 or more, preferably represents 1 to 100, more preferably 1 to 80, and still more preferably 1 to 60.

p pieces of [CRf₁Rf₂]uO's may be the same or different from each other.

### (d) Group Represented by Formula (1-d)

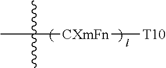

In Formula (1-d),
X represents a hydrogen atom or a substituent (preferably, a group represented by “SP—H” described above),
T10 represents a terminal group (preferably the same group as T1 described above),
1 represents an integer of 1 to 20, m represents an integer of 0 to 2, n represents an integer of 1 to 2, and m+n is 2, and
in a case where 1 is 2 or more, a plurality of —(CXmFn)-'s may be the same or different from each other.

In Formula (1-d), C represents a carbon atom, and F represents a fluorine atom.

In Formula (1-d), X is preferably a hydrogen atom, a halogen atom, an alkyl group having 1 to 10 carbon atoms, an alkoxy group having 1 to 10 carbon atoms, a cyano group, a nitro group, —OZ^{H}, —C(O)Z^{H}, —C(O)OZ^{H}, —OC(O)Z^{H}, —NZ^{H}Z^{H}′, —NZ^{H}C(O)Z^{H}′, —NZ^{H}C(O)OZ^{H}′, —C(O)NZ^{H}Z^{H}, or —OC(O)NZ^{H}Z^{H}′; and more preferably a hydrogen atom, a fluorine atom, —Z^{H}, or —OZ^{H}. Z^{H} and Z^{H}′ each independently represent a hydrogen atom, a halogen atom, an alkyl group having 1 to 10 carbon atoms, an alkoxy group having 1 to 10 carbon atoms, a cyano group, or a nitro group; and the number of carbon atoms thereof is preferably 1 to 4.

In Formula (1-d), T10 is preferably a hydrogen atom, a halogen atom, an alkyl group having 1 to 10 carbon atoms, a cyano group, a nitro group, —OZ^{H}, —C(O)Z^{H}, —C(O)OZ^{H}, —OC(O)Z^{H}, or a crosslinkable group represented by Formulae (P-1) to (P-30) described above; and more preferably a hydrogen atom, a fluorine atom, an alkyl group having 1 to 10 carbon atoms, a cyano group, a nitro group, —OZ^{H}, a vinyl group, a (meth)acryloyl group, a (meth)acrylamide group, a styryl group, a vinyl ether group, an epoxy group, or an oxetanyl group. Z^{H} represents a hydrogen atom, a halogen atom, an alkyl group having 1 to 10 carbon atoms, an alkoxy group having 1 to 10 carbon atoms, a cyano group, or a nitro group; and the number of carbon atoms thereof is preferably 1 to 4.

### (Repeating Unit F-2)

The repeating unit F-2 is a repeating unit represented by Formula (F-2).

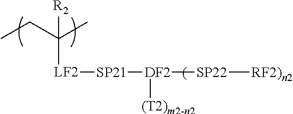

In Formula (F-2),
R2 represents a hydrogen atom, a fluorine atom, a chlorine atom, or an alkyl group having 1 to 4 carbon atoms, and LF2 represents the same group as LF1 in Formula (F-1) described above,
SP21 and SP22 each independently represent a spacer group,
DF2 represents an (m2+1)-valent group,
T2 represents a terminal group,
RF2 represents a group having a fluorine atom,
n2 represents an integer of 2 or more, m2 represents an integer of 2 or more, and m2≥n2, and
a plurality of —SP22-RF2's may be the same or different from each other, and in a case where a plurality of T2's are present, the plurality of T2's may be the same or different from each other.

In Formula (F-2), R2 represents a hydrogen atom, a fluorine atom, a chlorine atom, or an alkyl group having 1 to 4 carbon atoms, and preferably represents a hydrogen atom or a methyl group.

In Formula (F-2), DF2 represents an (m2+1)-valent group, and specific examples thereof include a tertiary carbon atom (—C(H)<), a quaternary carbon atom (>C<), a nitrogen atom, a phosphoric acid ester group (P(═O)(—O—)₃), a branched alkylene group having 2 to 20 carbon atoms, an aromatic ring having 4 to 15 carbon atoms, an aliphatic ring having 4 to 15 carbon atoms, and a heterocyclic ring.

The carbon atom in the branched alkylene group, the aromatic ring, and the aliphatic ring may be substituted with “SP—C” described above.

The hydrogen atom in the branched alkylene group, the aromatic ring, and the aliphatic ring may be substituted with “SP—H” described above.

It is preferable that DF2 is a carbon atom (a tertiary carbon atom or a quaternary carbon atom), a nitrogen atom, a benzene ring, a cyclohexane ring, or a cyclopentane ring.

SP21 and SP22 each independently represent a spacer group, and examples thereof include SPW in Formula (W1) described above.

It is preferable that SP21 and SP22 are each a single bond or a linear, branched, or cyclic alkylene group having 1 to 10 carbon atoms. Here, the carbon atom of the alkylene group may be substituted with —O—, —S—, —N(Z)—, —C(Z)═C(Z′)—, —C(O)—, —C(S)—, —OC(O)—, —OC(S)—, —SC(O)—, —C(O)O—, —C(S)O—, —C(O)S—, —O—C(O)O—, —N(Z)C(O)—, or —C(O)N(Z)—, (Z and Z′ each independently represent a hydrogen atom, an alkyl group having 1 to 4 carbon atoms, a cycloalkyl group, an aryl group, a cyano group, or a halogen atom). In addition, the hydrogen atom of the alkylene group may be substituted with a fluorine atom or a fluoroalkyl group.

T2 is preferably a hydrogen atom, a halogen atom, —OH, —COOH, an alkyl group having 1 to 10 carbon atoms, a cyano group, a nitro group, —OZ^{H}, —C(O)Z^{H}, —C(O)OZ^{H}, —OC(O)Z^{H}, or a crosslinkable group represented by Formulae (P-1) to (P-30); and more preferably a hydrogen atom, a fluorine atom, —OH, —COOH, —Z^{H}, —OZ^{H}, a vinyl group, a (meth)acryloyl group, a (meth)acrylamide group, a styryl group, a vinyl ether group, an epoxy group, or an oxetanyl group. Z^{H} represents a hydrogen atom, a halogen atom, an alkyl group having 1 to 10 carbon atoms, an alkoxy group having 1 to 10 carbon atoms, a cyano group, or a nitro group; and the number of carbon atoms thereof is preferably 1 to 4.

RF2 represents a group having a fluorine atom, and is preferably a fluorine atom, RF1 in Formula (F-1) described above, or a group having a fluorine atom as T2 described above.

In Formula (F-2), m2 is preferably 2 to 8 and more preferably 2 to 6. n2 is preferably 2 to 4 and more preferably 2 or 3.

The repeating unit represented by Formula (F-2) may be of a cleavage type in which the repeating unit undergoes cleavage by an acid or a base and RF2 is eliminated from a polymer side chain. As a result, upper layer coating properties are improved.

### (Repeating Unit S)

The repeating unit S is a repeating unit represented by Formula (S).

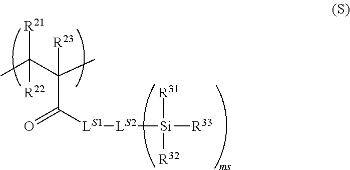

In Formula (S), ms represents an integer of 2 or more. ms is preferably an integer of 3 or more, more preferably an integer of 3 to 6, and still more preferably an integer of 3 to 5.

In Formula (S), R³¹, R³², and R³³ each independently represent an alkyl group, an alkenyl group, an aryl group, or an alkylene-aryl group. A plurality of R³¹'s may be the same or different from each other. A plurality of R³²'s may be the same or different from each other. A plurality of R³³'s may be the same or different from each other.

Here, examples of the alkyl group include a linear alkyl group having 1 to 18 carbon atoms and a branched or cyclic alkyl group having 3 to 18 carbon atoms.

Examples of the alkenyl group include an alkenyl group having 2 to 12 carbon atoms.

Examples of the aryl group include an aryl group having 6 to 12 carbon atoms. Specific examples thereof include a phenyl group, an α-methylphenyl group, and a naphthyl group.

Examples of the alkylene-aryl group include an alkylene-aryl group having 7 to 30 carbon atoms.

In Formula (S), R²¹ and R²² each independently represent a hydrogen atom or an alkyl group.

Examples of the alkyl group represented by one aspect of R²¹ and R²² include a linear alkyl group having 1 to 18 carbon atoms and a branched or cyclic alkyl group having 3 to 18 carbon atoms. Specific examples thereof include a methyl group, an ethyl group, a propyl group, a butyl group, an isopropyl group, a tert-butyl group, and a cyclohexyl group. R²¹ and R²² are preferably a hydrogen atom.

In Formula (S), R²³ represents a hydrogen atom or a substituent.

Examples of the substituent represented by one aspect of R²³ include an alkyl group, an alkenyl group, an aryl group, and a substituent having a linking group and containing a silicon atom. For example, —CH₂—CO-L^{S1}-L^{S2}-(Si(R³¹)(R³²)(R³³))ms is also included. L^{S1}, L^{S2}, R³¹, R³², R³³, and ms have the same definitions as the symbols in Formula (S), respectively.

R²³ is preferably an alkyl group, more preferably a linear alkyl group having 1 to 4 carbon atoms, and still more preferably a methyl group or an ethyl group. R²³ is preferably a hydrogen atom or a methyl group.

In Formula (S), L^{S1} represents —O— or —NR^{Z}—. R^{Z} represents a hydrogen atom or a substituent.

With regard to —NR^{Z}— represented by one aspect of L^{S1}, the substituent represented by one aspect of R^{Z} is preferably an alkyl group, more preferably a linear alkyl group having 1 to 4 carbon atoms, and still more preferably a methyl group or an ethyl group. L^{S1} is preferably —O— or —NH—, and more preferably —O—.

In Formula (S), L^{S2} represents an (ms+1)-valent linking group.

Suitable examples of the (ms+1)-valent linking group represented by L^{S2} include an (ms+1)-valent hydrocarbon group having 1 to 10 carbon atoms, which may have a substituent, in which a part of carbon atoms constituting the hydrocarbon group may be substituted with a heteroatom.

Here, as the substituent which may be included in the hydrocarbon group, an alkyl group is preferable, a linear alkyl group having 1 to 4 carbon atoms is more preferable, and a methyl group or an ethyl group is still more preferable.

In addition, examples of the heteroatom include a silicon atom, an oxygen atom, and a nitrogen atom.

Specific examples of L^{S2} include structural formulae K-1-L, K-2-L, and K-3-L shown below.

In the following structural formulae, * represents a bonding position to L^{S1} in Formula (S1), and ** represents a bonding position to the group represented by (—SiR³¹R³²R³³)ms in Formula (S1).

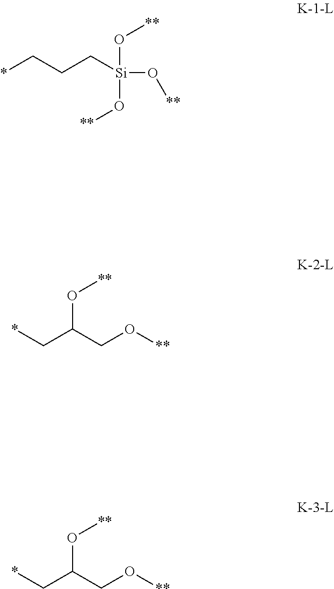

### (Repeating Unit A)

The repeating unit A is a repeating unit represented by Formula (A).

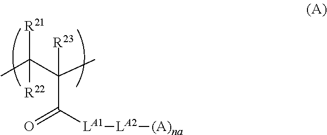

In Formula (A), R²¹, R²², and R²³ have the same definitions as the same symbols in Formula (S), respectively.

In Formula (A), L^{A1} represents a single bond or a divalent linking group.

Examples of the divalent linking group represented by one aspect of L^{A1} include —CO—, —O—, —S—, —C(═S)—, —CR¹R²—, —CR³═CR⁴—, —N^{R5}—, and a divalent linking group consisting of a combination of two or more of these groups. R¹ to R⁵ each independently represent a hydrogen atom, a fluorine atom, or an alkyl group having 1 to 12 carbon atoms.

Among these divalent linking groups, —O—, —S—, —CO—O—, —CO—NR⁵—, or —CO—S— is preferable, and —CO—O— or —CO—NR⁵— is more preferable.

In Formula (A), na represents an integer of 1 to 8.

na preferably represents an integer of 1 to 4, and more preferably represents 1 or 2. In a case where na represents 1, L^{A2} represents a single bond.

In Formula (A), L^{A2} represents a single bond or an (na+1)-valent linking group.

Examples of the (na+1)-valent linking group represented by one aspect of L^{A2} include an alkylene group, an ether group (—O—), a thioether group (—S—), a tertiary carbon atom, a quaternary carbon atom, and a linking group consisting of a combination thereof.

Suitable specific examples thereof include a trivalent linking group consisting of a combination of an alkylene group having 1 to 6 carbon atoms, a tertiary carbon atom bonded to the alkylene group, and two ether groups bonded to the tertiary carbon atom; and a tetravalent linking group consisting of a combination of an alkylene group having 1 to 6 carbon atoms, a quaternary carbon atom bonded to the alkylene group, and three ether groups bonded to the quaternary carbon atom.

In Formula (A), A represents an alkyl group having 5 to 40 carbon atoms and having three or more terminal methyl groups (hereinafter, also referred to as “specific alkyl group”). Here, in a case where na represents an integer of 2 to 8, a plurality of A's may be the same or different from each other.

Here, the “terminal methyl group” refers to a methyl group constituting a terminal of a linear or branched alkyl group; and for example, a linear alkyl group such as a n-propyl group and a n-butyl group is an alkyl group having one terminal methyl group, an isopropyl group is an alkyl group having two terminal methyl groups, and a tert-butyl group is an alkyl group having three terminal methyl groups.

Therefore, for example, a n-hexyl group has 6 carbon atoms, but is an alkyl group having only one terminal methyl group, and thus does not correspond to the specific alkyl group. On the other hand, all of the alkyl groups represented by Formulae (a-1) to (a-4) have 5 to 40 carbon atoms and have three or more terminal methyl groups (methyl groups surrounded by a dotted line in the formulae), and thus correspond to the specific alkyl group.

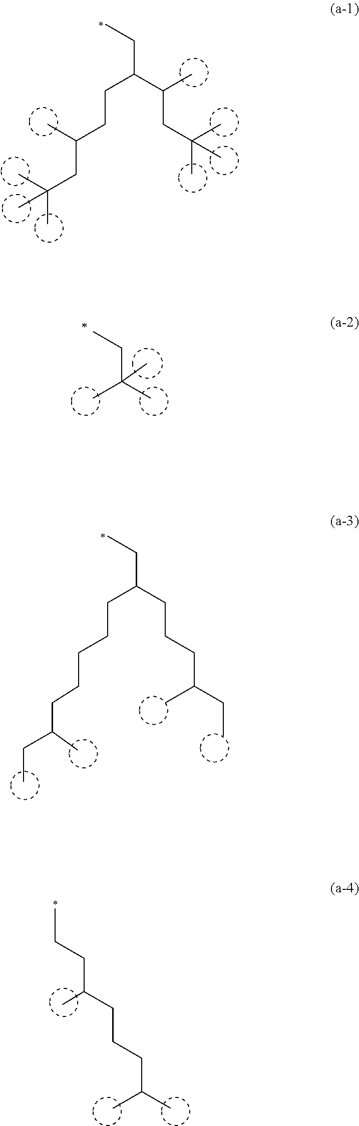

The number of terminal methyl groups in the specific alkyl group is preferably 3 to 15 and more preferably 3 to 10.

In addition, the number of carbon atoms in the specific alkyl group is preferably 5 to 30 and more preferably 5 to 20.

In addition, a proportion of the number of terminal methyl groups to the number of carbon atoms in the specific alkyl group (Number of terminal methyl groups/Number of carbon atoms in the specific alkyl group) is preferably 0.4 or more, and more preferably 0.4 or more and 0.6 or less.

As the specific alkyl group, an alkyl group represented by any of Formulae (a-1) to (a-4) described above is preferable.

The first constitutional unit is exemplified below, but the first constitutional unit is not limited to the following examples.

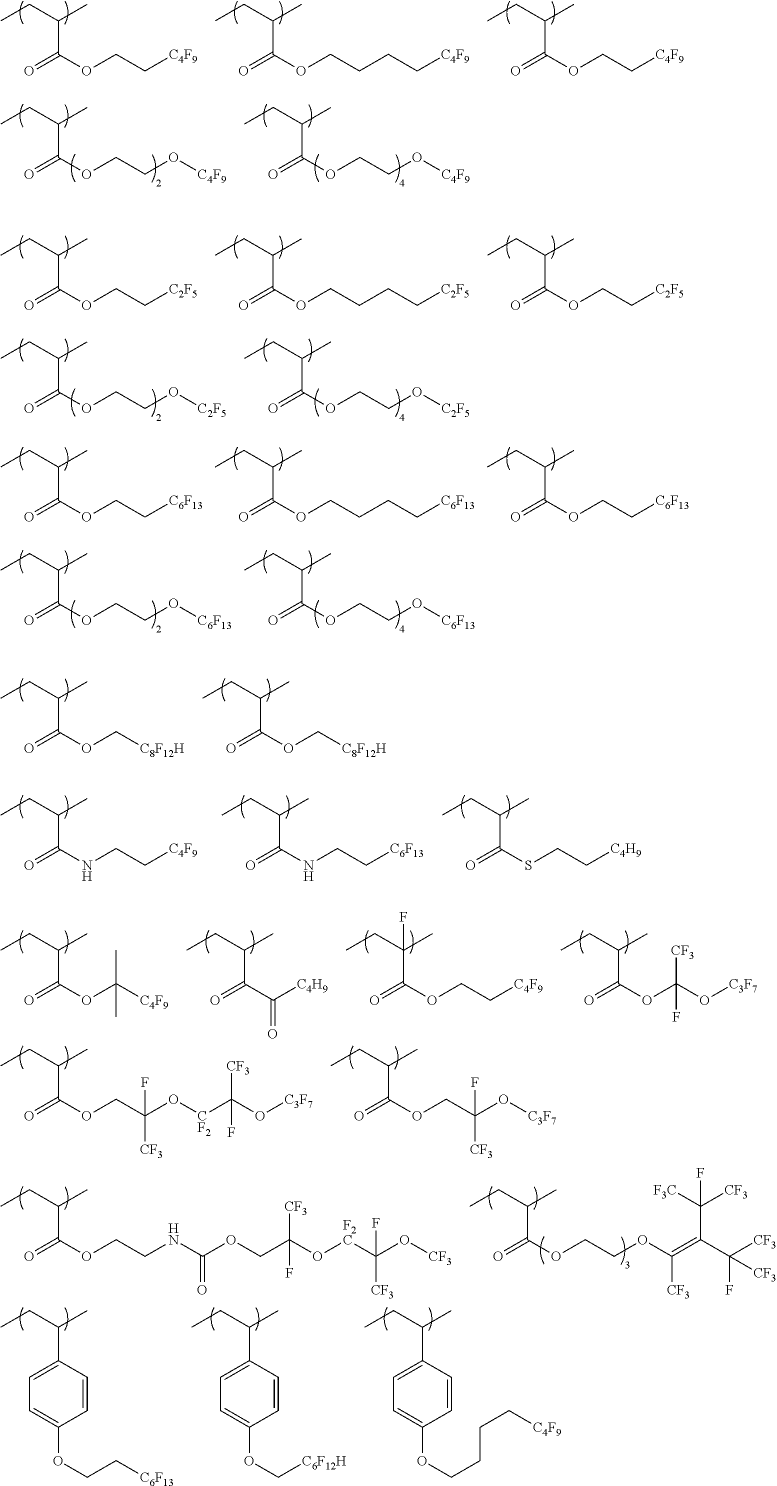

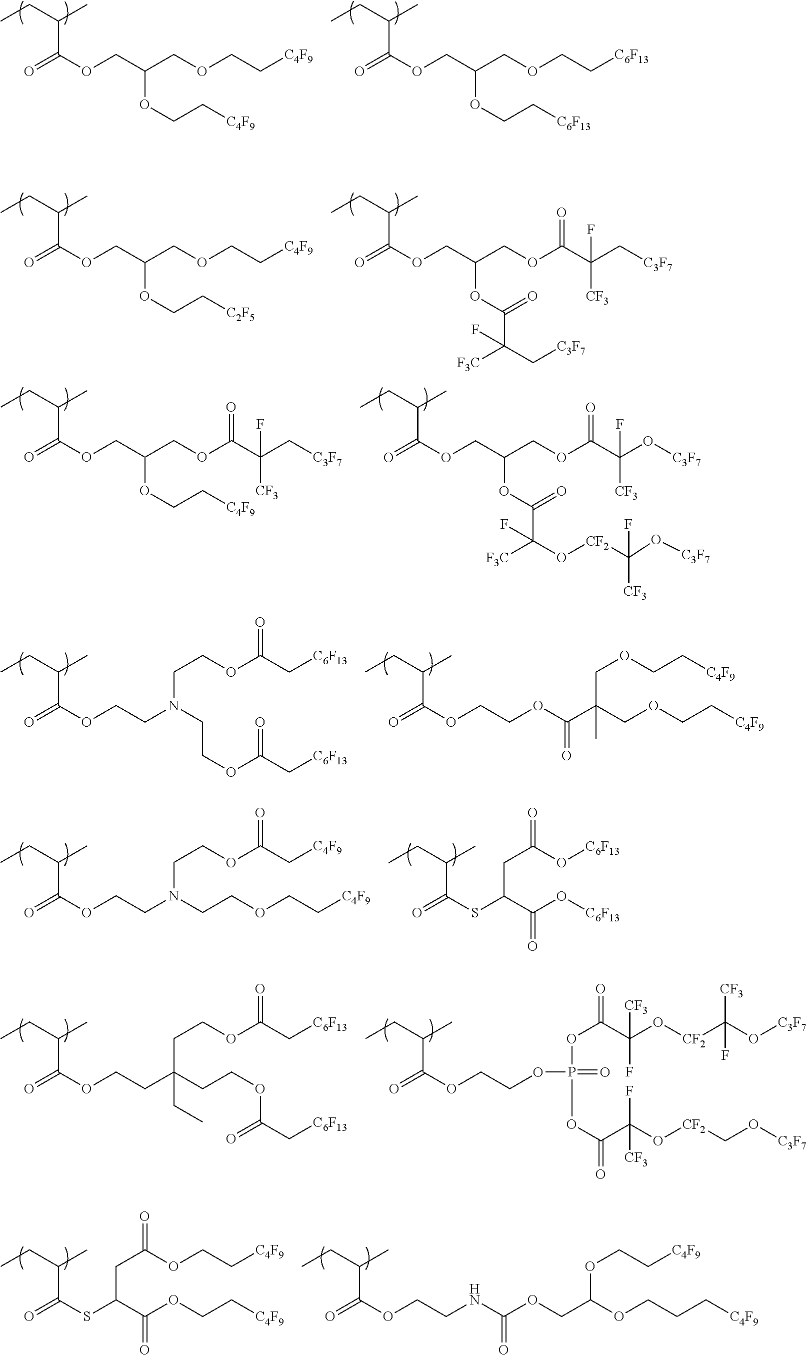

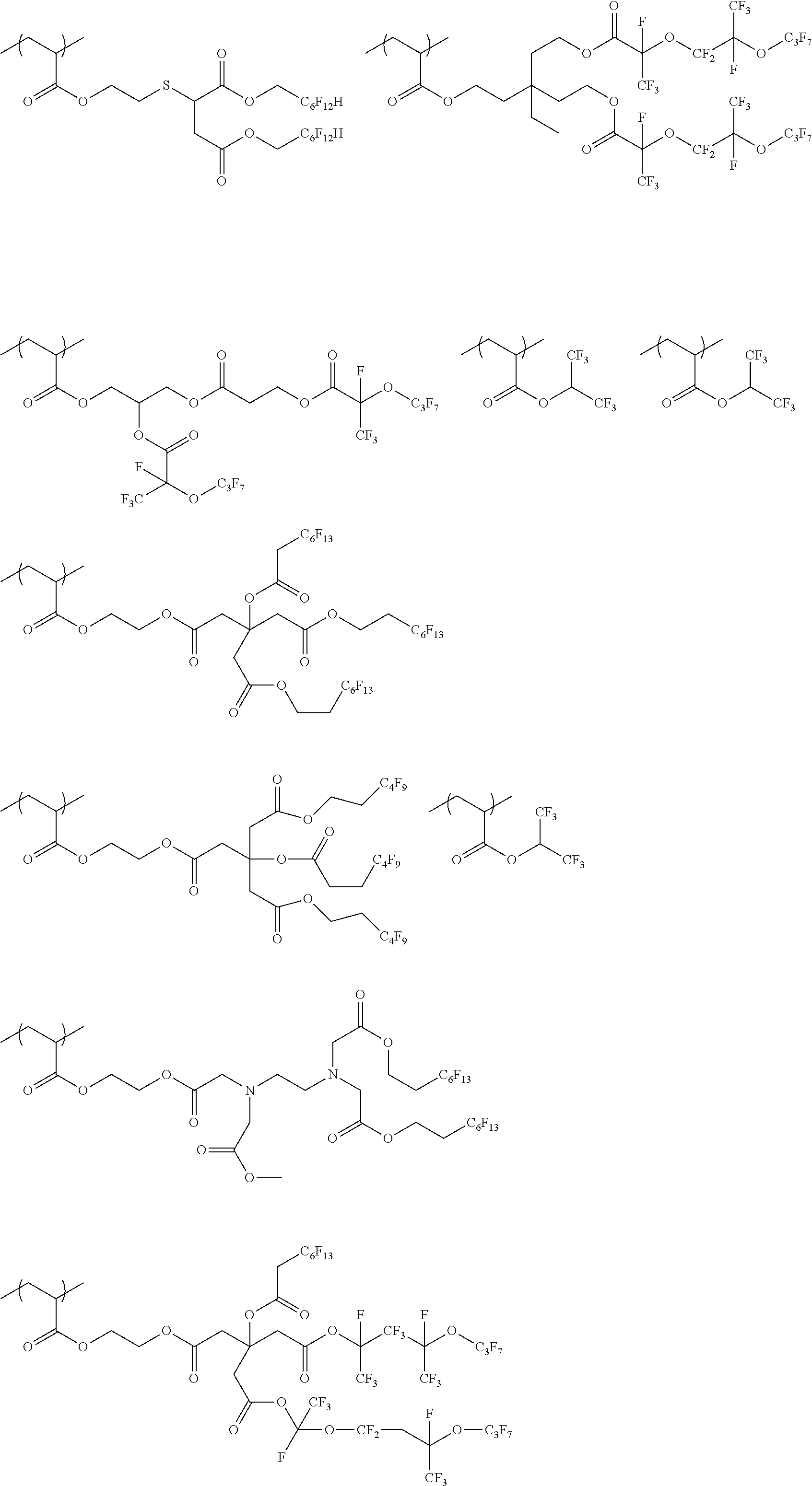

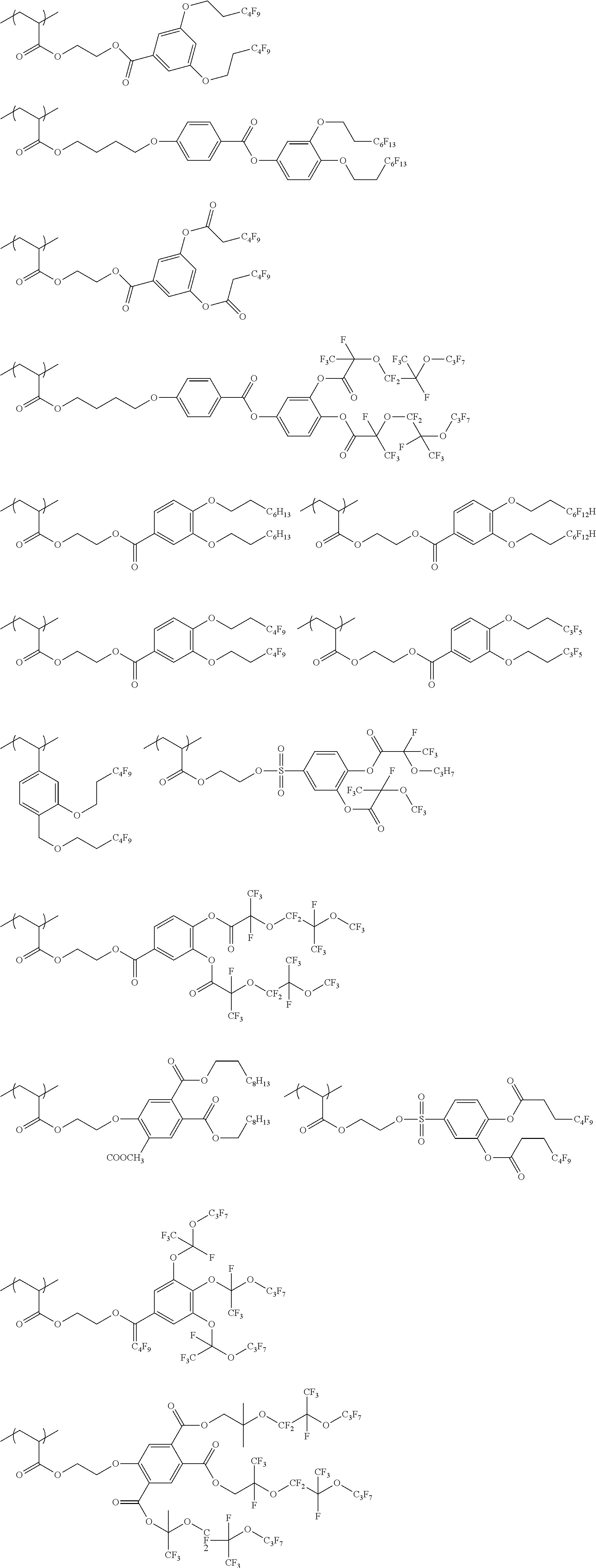

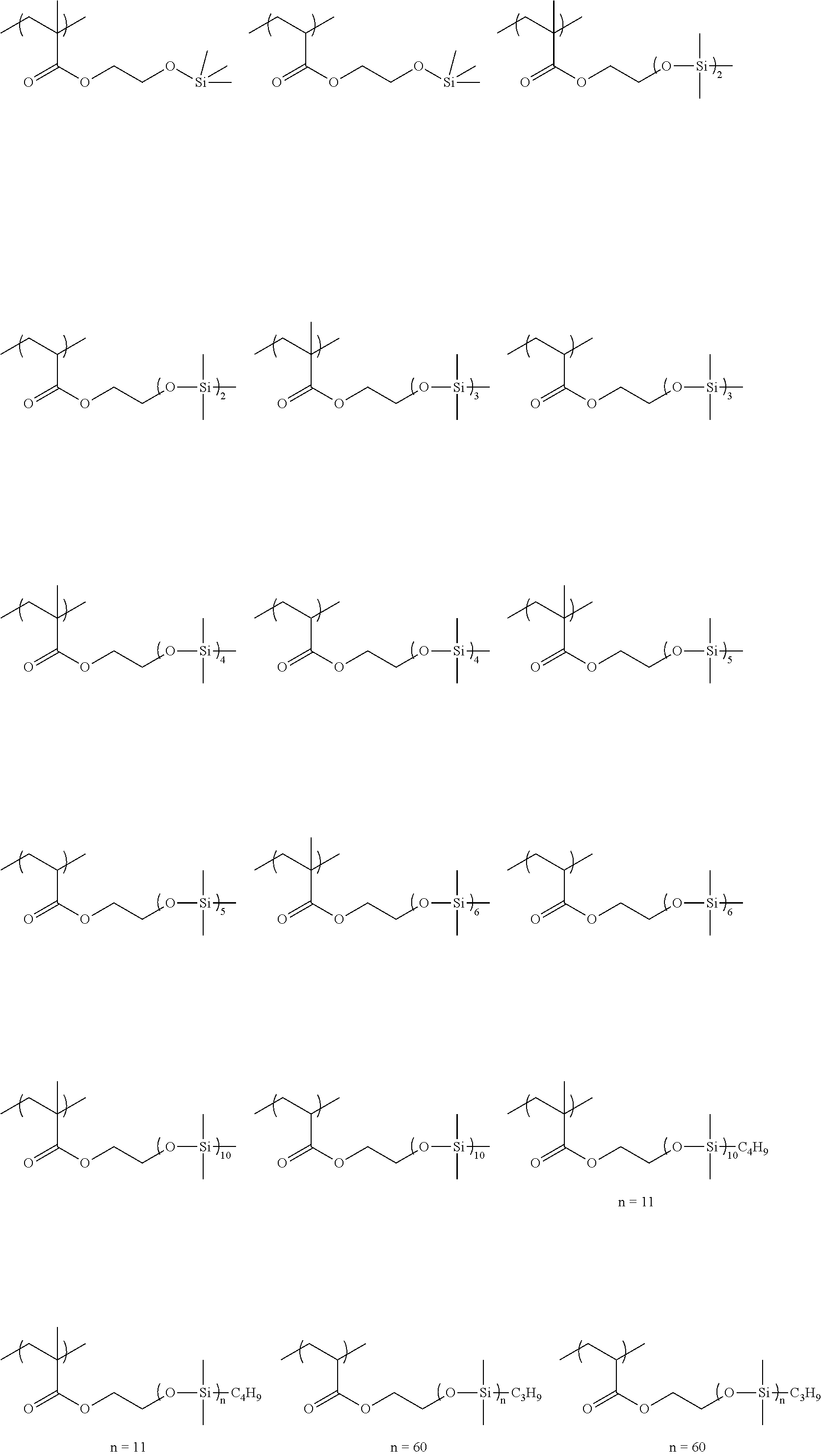

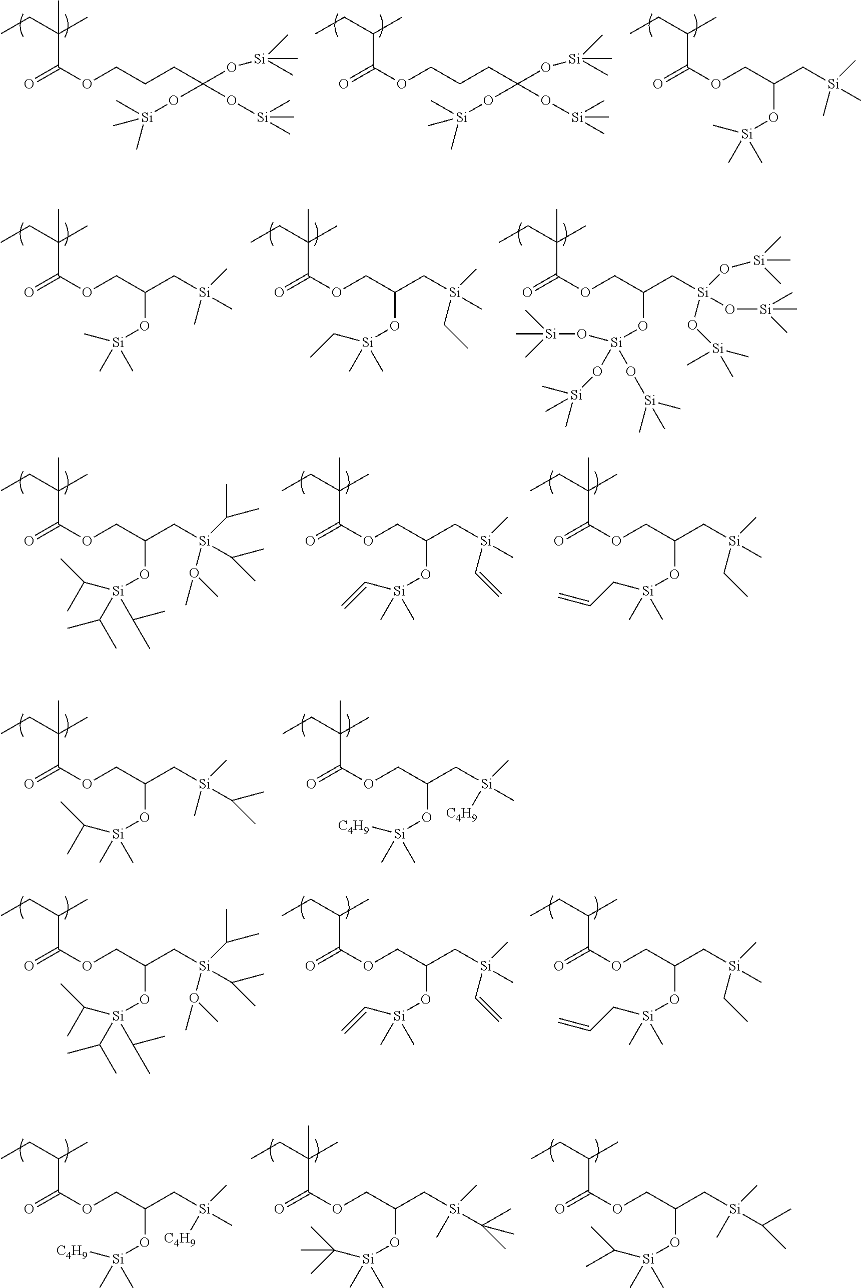

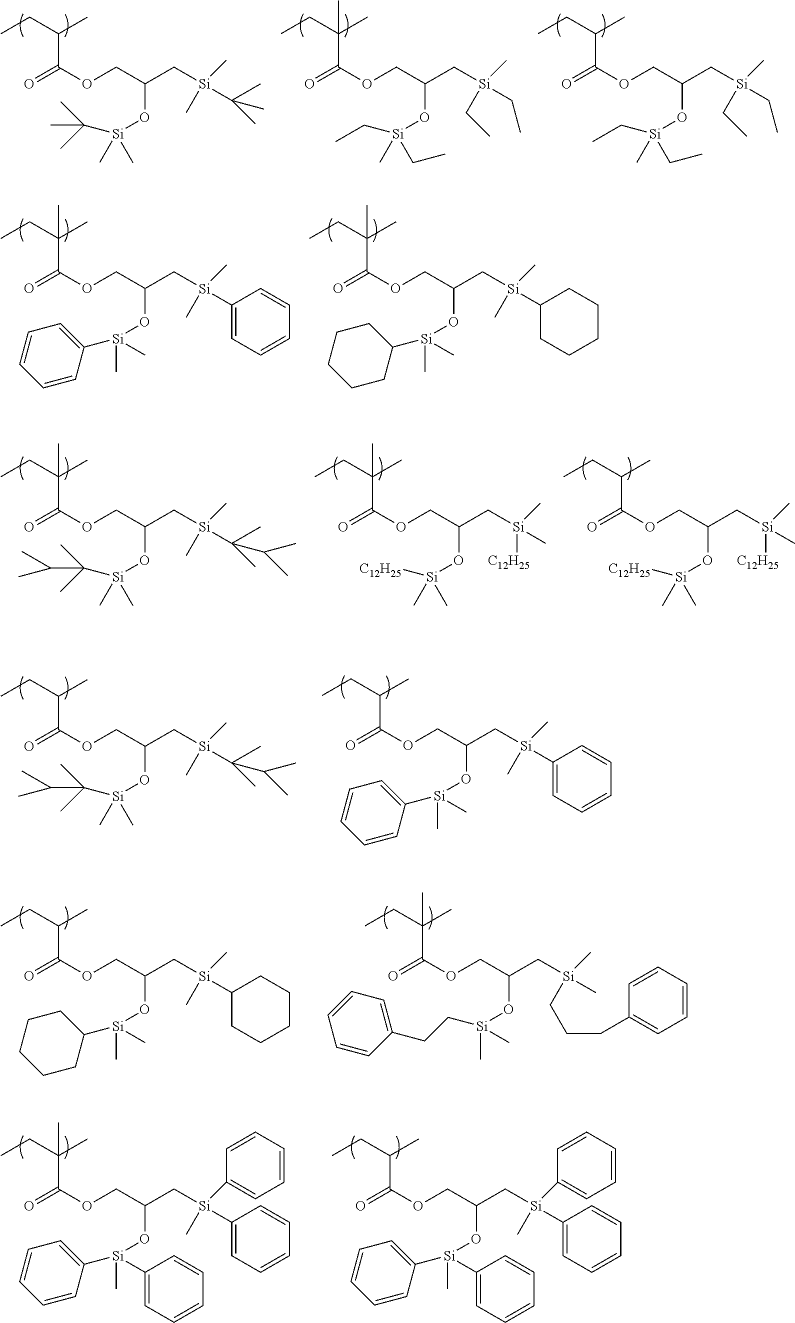

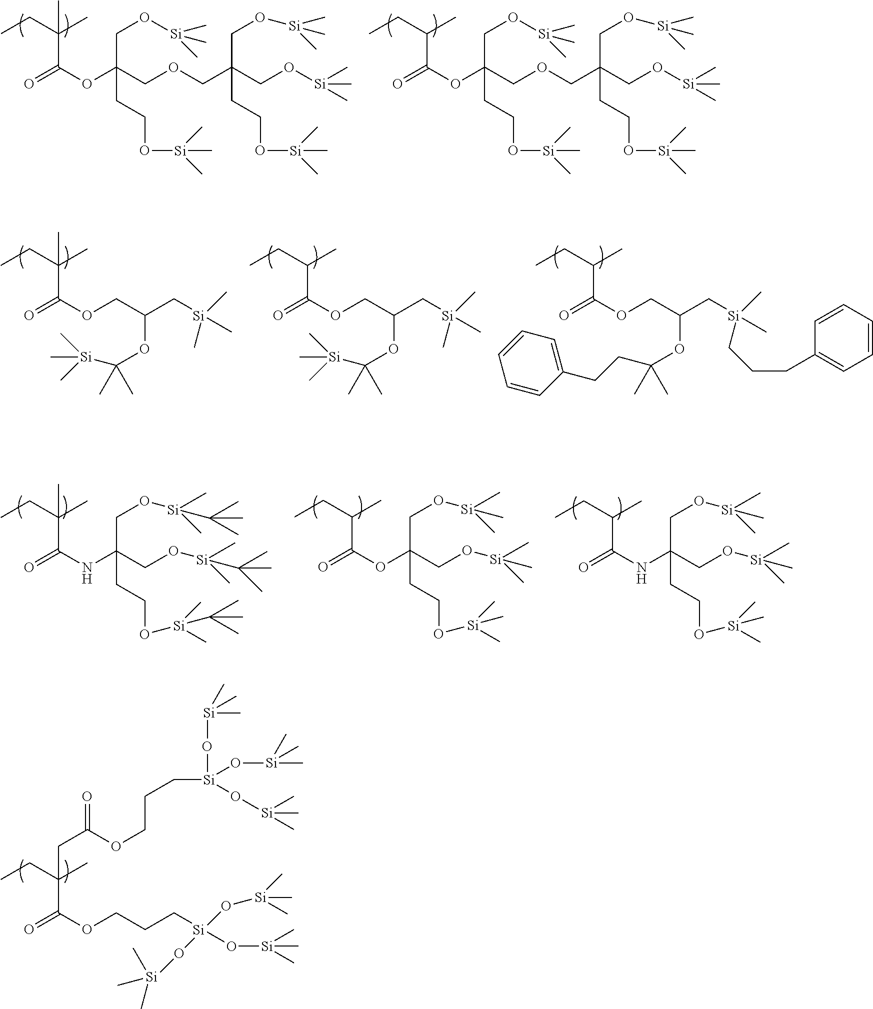

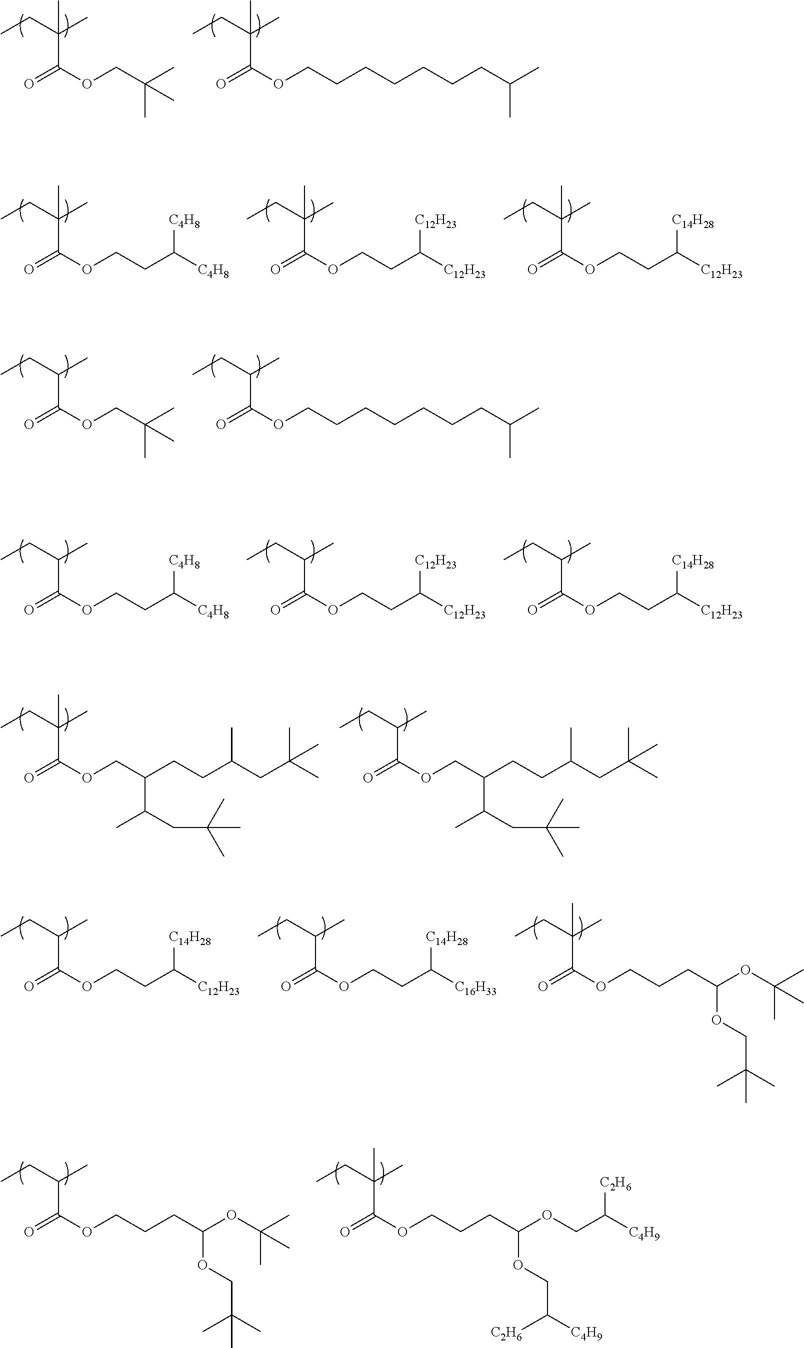

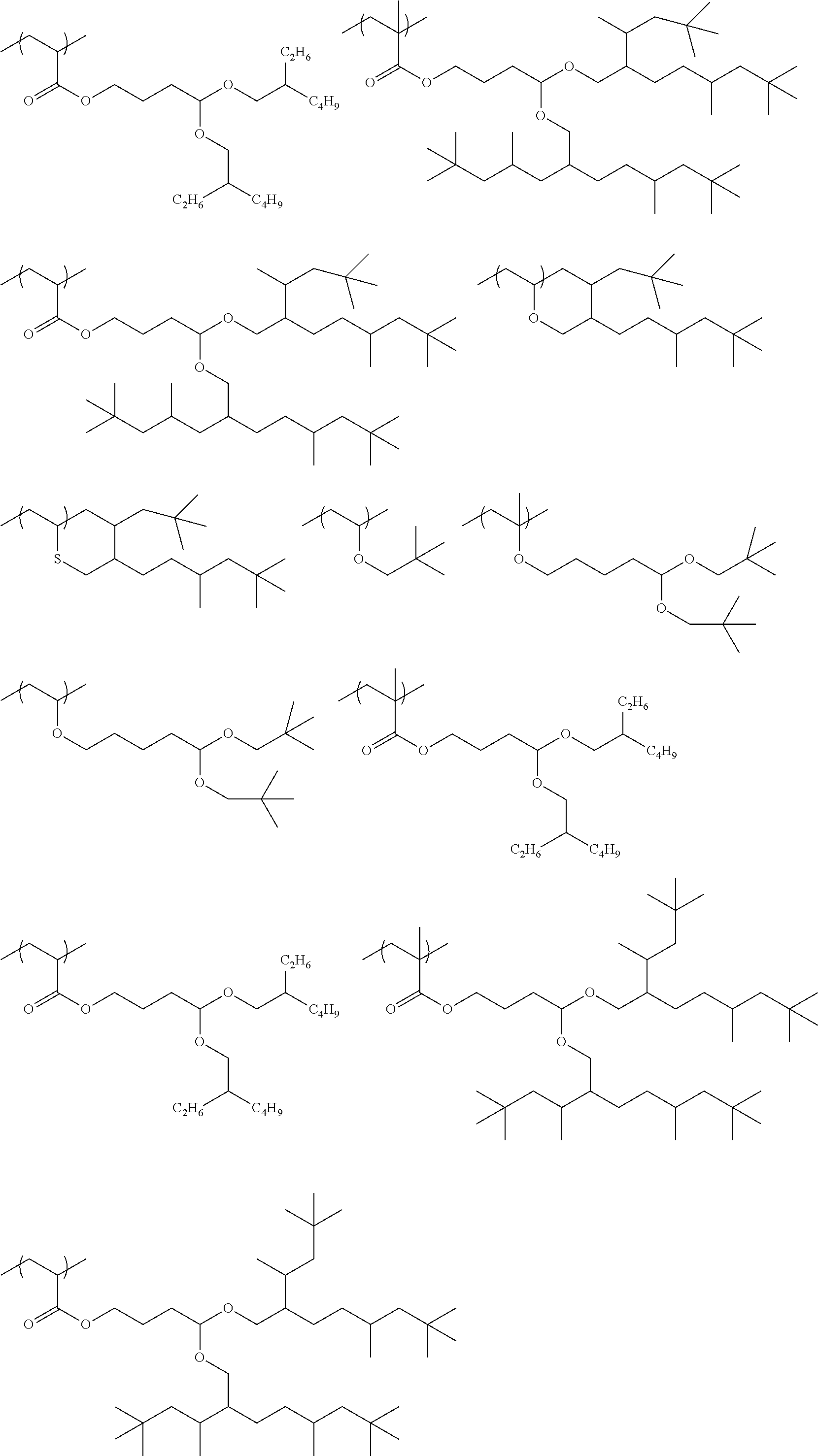

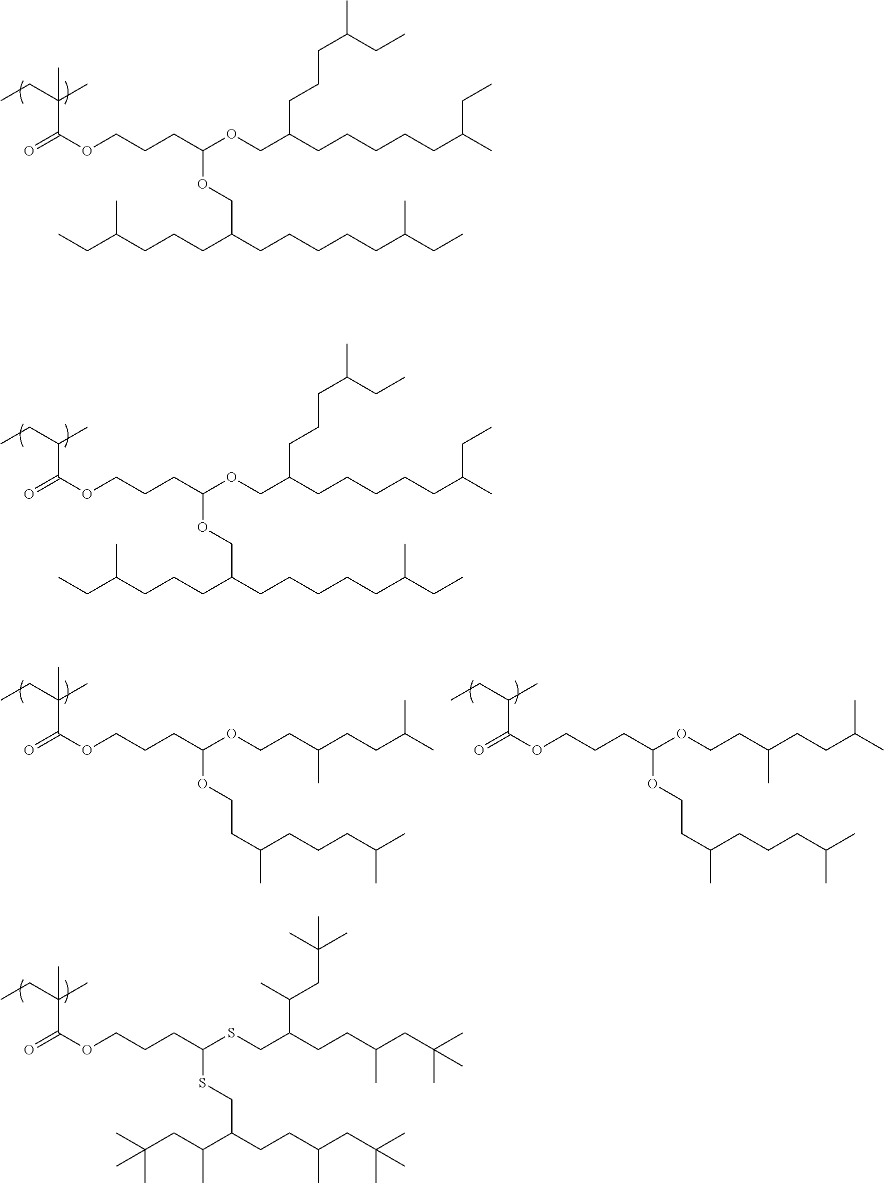

Among these constitutional units, from the viewpoint of environmental protection, the first constitutional unit is preferably a constitutional unit having the repeating unit S or the repeating unit A.

### <Second Constitutional Unit>

### (Repeating Unit M)

The repeating unit M is a repeating unit represented by Formula (M).

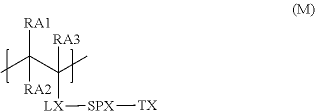

In Formula (M), R^{A1} and R^{A2} each independently represent a hydrogen atom or an alkyl group.

Examples of the alkyl group in R^{A1} and R^{A2} include a linear alkyl group having 1 to 18 carbon atoms (preferably having 1 to 6 carbon atoms and more preferably having 1 to 4 carbon atoms), and a branched or cyclic alkyl group having 3 to 18 carbon atoms (preferably having 3 to 9 carbon atoms and more preferably having 3 to 6 carbon atoms). Specific examples thereof include a methyl group, an ethyl group, a propyl group, a butyl group, an isopropyl group, a tert-butyl group, and a cyclohexyl group. It is preferable that both R^{A1} and R^{A2} are hydrogen atoms.

In Formula (M), R^{A3} represents a hydrogen atom, a halogen atom, or a substituent.

Specific examples of the substituent in R^{A3} include an alkyl group, an alkenyl group, and an aryl group.

The substituent in R^{A3} is preferably an alkyl group, more preferably a linear alkyl group having 1 to 4 carbon atoms, and still more preferably a methyl group or an ethyl group. It is preferable that R^{A3} is a hydrogen atom or a methyl group.

In Formula (M), LX represents a single bond or a divalent linking group; and more specific examples thereof include a group represented by -LW-SPW— in Formula (W1) described above, an aromatic hydrocarbon group having 4 to 20 carbon atoms, a cyclic alkylene group having 4 to 20 carbon atoms, and a heterocyclic group having 1 to 20 carbon atoms, and among these, LX is preferably a linear, branched, or cyclic alkylene group having 1 to 20 carbon atoms or an aromatic hydrocarbon group having 4 to 20 carbon atoms, and more preferably includes —O—, —C(O)—O—, —C(O)—NH—, or —O—C(O)—.

In Formula (M), SPX represents a divalent spacer group. The divalent spacer group in SPX is preferably a linear, branched, or cyclic alkylene group having 1 to 20 carbon atoms or an aromatic hydrocarbon group having 4 to 20 carbon atoms (preferably 6 to 20 carbon atoms), and the carbon atom of the alkylene group may be substituted with SP—C described above.

Among SP—C described above, —O—, —Si(CH₃)₂—, —(Si(CH₃)₂O)_{g}— (g represents an integer of 1 to 10), —C(Z)₂—C(Z′)₂—, —C(O)—, —C(O)O—, —O—C(O)O—, —C(O)N(Z)—(Z and Z′ each independently represent a hydrogen atom, an alkyl group having 1 to 4 carbon atoms, a cycloalkyl group, an aryl group, a cyano group, or a halogen atom), —S—, —S(O)—, or —S(O)(O)— is preferable.

TX represents a group represented by Formula (M1) or a group represented by Formula (M2).

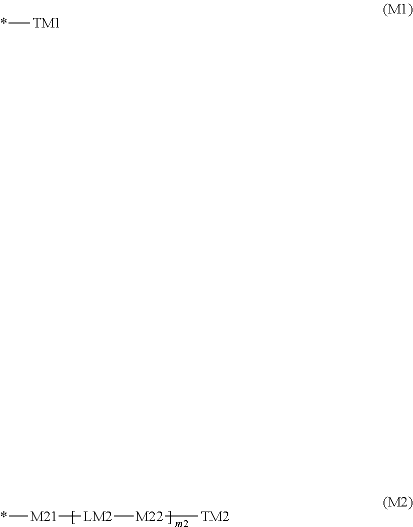

In Formulae (M1) and (M2), * represents a linking portion to SPX.

In Formula (M1),
TM1 represents —COOH, —CSOH, —OH, —NR^{M1}R^{M2}, —SO₃H, or —PO₄H, and
R^{M1} and R^{M2} each independently represent a hydrogen atom or an alkyl group having 1 to 6 carbon atoms.

It is preferable that TM1 is —COOH or —NR^{M1}R^{M2}.

In Formula (M2),
m2 represents an integer of 1 to 4,
M21 and M22 each independently represent an aromatic ring, an aliphatic ring, or a heterocyclic ring, which may have a substituent, in which, in a case where m2 is 2 or more, a plurality of M22's may be the same or different from each other,
LM2 represents a single bond or a divalent linking group, and more specifically represents a group represented by -LW-SPW— in Formula (W1) described above, in which, in a case where m2 is 2 or more, a plurality of LM2's may be the same or different from each other, and
TM2 represents a terminal group.
M21 and M22 represent an aromatic ring, an aliphatic ring, or a heterocyclic ring, which may have a substituent, and preferably represent a 4- to 15-membered ring. M21 and M22 may be a monocyclic ring or a fused ring, and a plurality of M21's or M22's may be the same or different from each other.

Examples of the aromatic ring represented by M21 and M22 include a phenylene group, a naphthylene group, a fluorene-diyl group, an anthracene-diyl group, and a tetracene-diyl group, and from the viewpoint of design diversity of the mesogenic skeleton and the availability of raw materials, a phenylene group or a naphthylene group is preferable.

Examples of the aliphatic ring represented by M21 and M22 include a cyclopentylene group and a cyclohexylene group, and the carbon atom thereof may be substituted with —O—, —Si(CH₃)₂—, —N(Z)—, —C(O)—, —S—, —C(S)—, —S(O)—, —SO₂—, or a group formed by combining two or more of these groups. Z represents a hydrogen atom, an alkyl group having 1 to 4 carbon atoms, a cycloalkyl group, an aryl group, a cyano group, or a halogen atom.

Examples of an atom other than carbon, constituting the heterocyclic ring represented by M21 and M22, include a nitrogen atom, a sulfur atom, and an oxygen atom. In a case where the heterocyclic ring has a plurality of atoms other than carbon, constituting a ring, these atoms may be the same or different from each other. Specific examples of the heterocycle include a pyridylene group (pyridine-diyl group), a pyridazine-diyl group, an imidazole-diyl group, thienylene (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimide-diyl group, a thienothiazole-diyl group, a thiazolothiazole-diyl group, a thienothiophene-diyl group, a thienooxazole-diyl group, and the following structures (II-1) to (II-4).

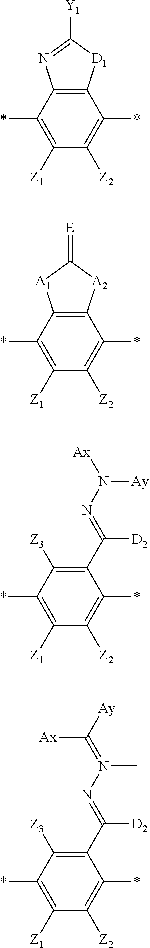

In Formulae (II-1) to (II-4),
D₁ represents —S—, —O—, or NR¹¹—, where R¹¹ represents a hydrogen atom or an alkyl group having 1 to 6 carbon atoms,
Y₁ represents an aromatic hydrocarbon group having 6 to 12 carbon atoms or an aromatic heterocyclic group having 3 to 12 carbon atoms,
Z₁, Z₂, and Z₃ each independently represent a hydrogen atom or an aliphatic hydrocarbon group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, —NR¹²R¹³, or —SR¹², where Z₁ and Z₂ may be bonded to each other to form an aromatic ring or an aromatic heterocyclic ring, and R¹² and R¹³ each independently represent a hydrogen atom or an alkyl group having 1 to 6 carbon atoms,
A₁ and A₂ each independently represent a group selected from the group consisting of —O—, —NR²¹—(R²¹ represents a hydrogen atom or a substituent), —S—, and CO—,
E represents a non-metal atom of Group 14 to Group 16, to which a hydrogen atom or a substituent may be bonded,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 6 carbon atoms, which may have a substituent, or an organic group having 2 to 30 carbon atoms, which has at least one aromatic ring selected from the group consisting of an aromatic hydrocarbon ring and an aromatic heterocyclic ring, in which the aromatic rings of Ax and Ay may have a substituent and Ax and Ay may be bonded to each other to form a ring, and
D₂ represents a hydrogen atom or an alkyl group having 1 to 6 carbon atoms, which may have a substituent.

In Formula (II-2), in a case where Y₁ represents an aromatic hydrocarbon group having 6 to 12 carbon atoms, the aromatic hydrocarbon group may be monocyclic or polycyclic. In a case where Y₁ represents an aromatic heterocyclic group having 3 to 12 carbon atoms, the aromatic heterocyclic group may be monocyclic or polycyclic.

In Formula (II-2), in a case where A₁ and A₂ represent —NR²¹—, the substituent as R²¹ can refer to, for example, description in paragraphs 0035 to 0045 of JP2008-107767 Å, and the content thereof is incorporated in the present specification.

In Formula (II-2), in a case where E represents a non-metal atom of Group 14 to Group 16, to which a substituent may be bonded, ═O, ═S, ═NR′, or ═C(R′)R′ is preferable. R′ represents a substituent, as the substituent, for example, the description in paragraphs [0035] to [0045] of JP2008-107767A can be referred to, and an oxygen atom or a sulfur atom is preferable.

Regarding M21 and M22 in Formula (M2), examples of the substituent which may be included in the aromatic ring, the aliphatic ring, or the heterocyclic ring include a halogen atom, an alkyl group having 1 to 20 carbon atoms, a halogenated alkyl group having 1 to 20 carbon atoms, a cycloalkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (also referred to as a hetero ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), and other known substituents.

Details of the substituent are described in paragraph [0023] of JP2007-234651 Å.

LM2 represents a single bond or a divalent linking group, and more specifically represents a group represented by -LW-SPW— in Formula (W1) described above; and among the above, an alkylene group having 2 to 12 carbon atoms, a fluorinated alkylene group having 2 to 12 carbon atoms, —(OC₂H₄)_{g}O—, —(OC₃H₆)_{g}O—, or —(Si(CH₃)₂O)_{g}— (g represents an integer of 1 to 10) is preferable.

TM2 represents a terminal group. More specific examples thereof include a hydrogen atom, a halogen atom, an alkyl group having 1 to 10 carbon atoms, an alkoxy group having 1 to 10 carbon atoms, an alkylthio group having 1 to 10 carbon atoms, an alkylamino group having 1 to 10 carbon atoms, an alkylsulfonyl group having 1 to 10 carbon atoms, an alkylaminocarbonyl group having 1 to 10 carbon atoms, an alkylaminosulfonyl group having 1 to 10 carbon atoms, an alkylcarbonylamino group having 1 to 10 carbon atoms, an alkoxycarbonyl group having 1 to 10 carbon atoms, a C1 to 10 alkylcarbonyloxy group, and an alkylsulfonylamino group having 1 to 10 carbon atoms; and a hydrogen atom, a halogen atom, an alkyl group, an alkoxy group, an alkylthio group, an alkoxycarbonyl group, or an alkylcarbonyloxy group is preferable.

The second constitutional unit is exemplified below, but the second constitutional unit is not limited to the following examples.

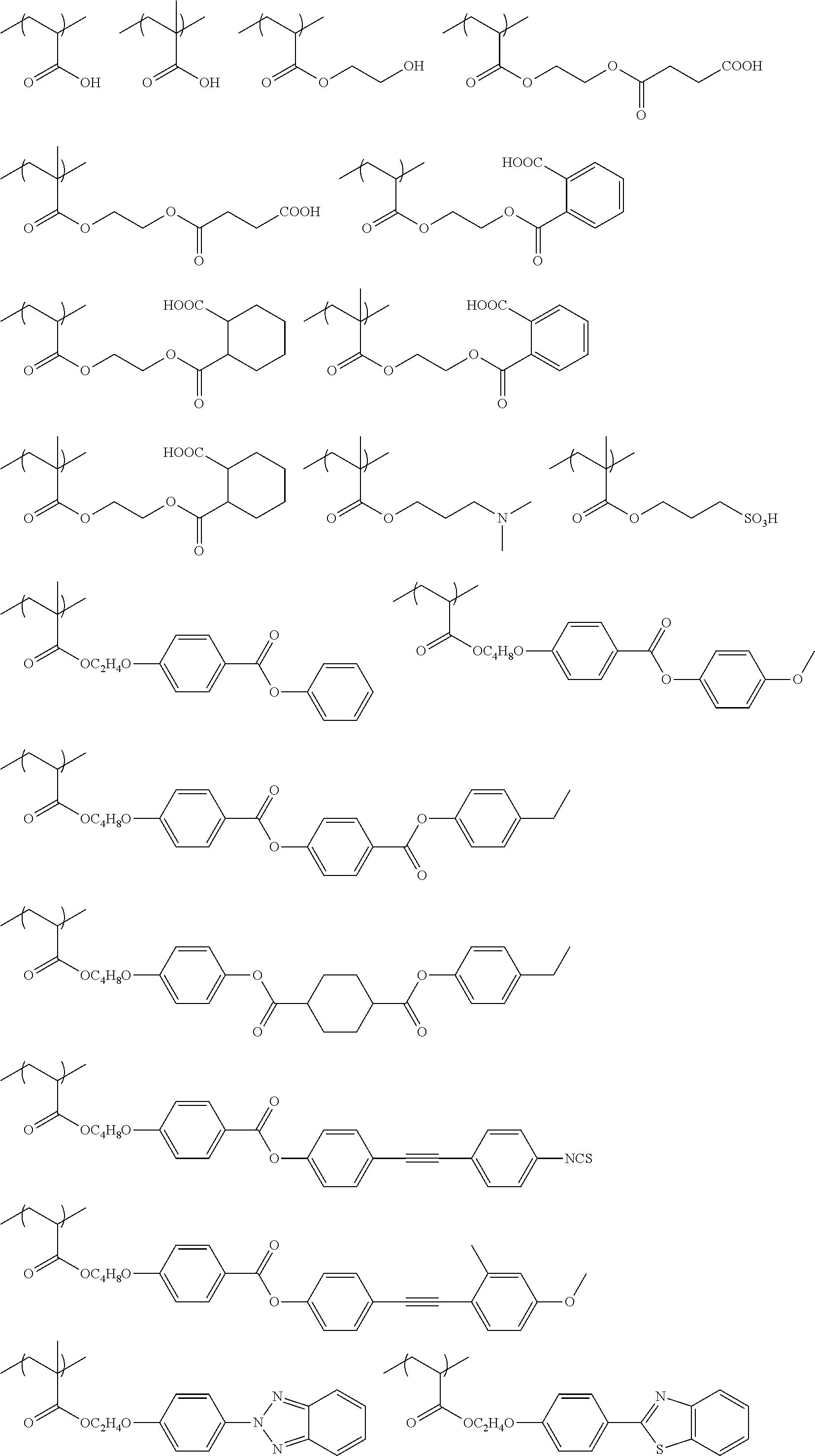

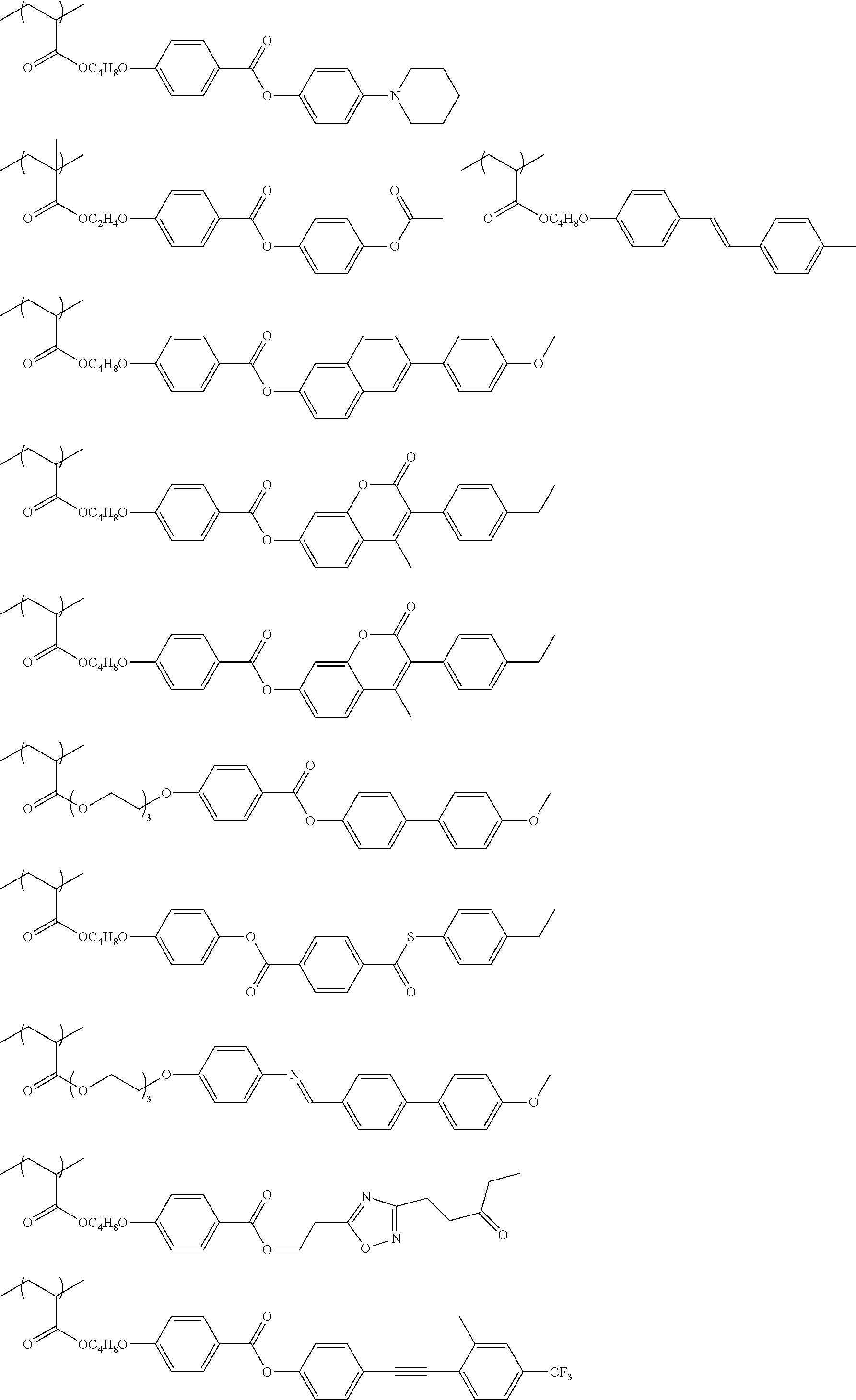

In a case where the high-molecular-weight surfactant has the first constitutional unit, a content of the first constitutional unit is preferably 10.0% to 80.0% by mass, more preferably 15.0% to 75.0% by mass, and still more preferably 20.0% to 70.0% by mass with respect to all units of the high-molecular-weight surfactant.

In a case where the high-molecular-weight surfactant has the second constitutional unit, a content of the second constitutional unit is preferably 5.0% to 80.0% by mass, more preferably 17.0 to 75.0% by mass, and still more preferably 10.0% to 70.0% by mass with respect to all units of the high-molecular-weight surfactant.

### <Third Constitutional Unit>

In a case where the high-molecular-weight surfactant has the first constitutional unit and the second constitutional unit, the high-molecular-weight surfactant may further have a unit (hereinafter, also referred to as “third constitutional unit”) in addition to the first constitutional unit and the second constitutional unit.

Specific examples of the third constitutional unit are shown below.

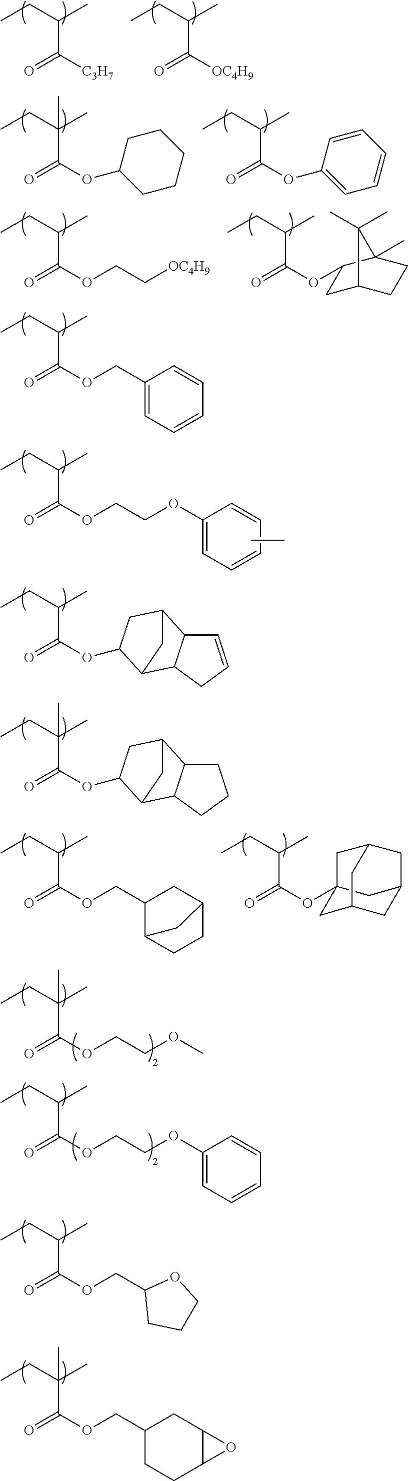

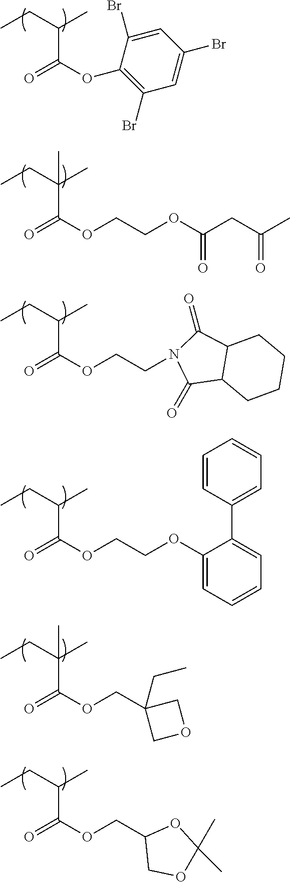

In a case where the high-molecular-weight surfactant has the third constitutional unit, a content of the third constitutional unit is preferably 1.0% to 80.0% by mass, more preferably 3.0% to 75.0% by mass, and still more preferably 5.0% to 70.0% by mass with respect to all units of the high-molecular-weight surfactant.

A content of the surfactant (particularly, the high-molecular-weight surfactant) is preferably 0.10 to 30.0 parts by mass, more preferably 0.15 to 20.0 parts by mass, and still more preferably 0.20 to 10.0 parts by mass with respect to 100 parts by mass of the specific organic coloring agent.

In a case where the content of the surfactant is 0.10 parts by mass or more, the effect of reducing the transmission loss is further improved, and the alignment degree is further improved. In a case where the content of the surfactant is 30.0 parts by mass or less, the electro-optical coefficient can be further increased.

A weight-average molecular weight (Mw) of the high-molecular-weight surfactant is preferably 4,000 to 200,000, more preferably 6,000 to 100,000, and still more preferably 8,000 to 70,000.

Here, the weight-average molecular weight of the high-molecular-weight surfactant is a value measured by a gel permeation chromatography (GPC) method.
Solvent (eluent): tetrahydrofuran
Device name: TOSOH HLC-8220GPC
Column: Three items of TOSOH TSKgel Super HZM-H (4.6 mm×15 cm) are connected and used.
Column temperature: 25° C.
Sample Concentration: 0.1% by mass
Flow rate: 0.35 mL/min
Calibration curve: TSK standard polystyrene (manufactured by TOSOH Corporation), calibration curves of 7 samples with Mw of 2,800,000 to 1,050 (Mw/Mn=1.03 to 1.06) are used

### [Solvent]

From the viewpoint of workability and the like, the present composition preferably contains a solvent.

Examples of the solvent include organic solvents such as ketones (such as acetone, 2-butanone, methyl isobutyl ketone, cyclopentanone, and cyclohexanone), ethers (such as dioxane, tetrahydrofuran, tetrahydropyran, dioxolane, tetrahydrofurfuryl alcohol, and cyclopentyl methyl ether), aliphatic hydrocarbons (such as hexane), alicyclic hydrocarbons (such as cyclohexane), aromatic hydrocarbons (such as benzene, toluene, xylene, and trimethylbenzene), halogenated carbons (such as dichloromethane, trichloromethane (chloroform), dichloroethane, dichlorobenzene, and chlorotoluene), esters (such as methyl acetate, ethyl acetate, butyl acetate, and diethyl carbonate), alcohols (such as ethanol, isopropanol, butanol, and cyclohexanol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine), and water. These solvents may be used alone or in combination of two or more kinds thereof.

Among these solvents, from the viewpoint that the effect of the present invention is more excellent, it is preferable to use an organic solvent and it is more preferable to use halogenated carbons or ketones.

In a case where the present composition contains a solvent, a content of the solvent is preferably 50.0% to 98.0% by mass, more preferably 45.0% to 95.0% by mass, and still more preferably 40.0% to 93.0% by mass with respect to the total mass of the present composition.

### [Other Components]

The present composition may contain components (hereinafter, also referred to as “other components”) other than the liquid crystal compound, the specific organic coloring agent, the surfactant, and the solvent described above.

Examples of the other components include a polymerization initiator and an adhesive.

### [Electro-Optical Layer]

The electro-optical layer according to the present invention (hereinafter, also referred to as “EO layer”) is an EO layer formed of the above-described present composition, in which the specific organic coloring agent contained in the EO layer is aligned.

In the present invention, from the viewpoint of reducing power consumption, the alignment degree of the specific organic coloring agent contained in the EO layer is preferably 0.20 or more, more preferably 0.21 or more, still more preferably 0.30 or more, and particularly preferably 0.40 or more.

In addition, there is a method of increasing the alignment degree to 0.95 or more by crystallization of the specific organic coloring agent, but light scattering of fine particles occurs due to crystallization of the specific organic coloring agent, which reduces a light transmission efficiency in the fiber, so that the alignment degree of the organic coloring agent contained in the EO layer is preferably 0.99 or less, more preferably 0.98 or less, and still more preferably 0.95 or less. In a case where the specific organic coloring agent is not crystallized, the upper limit of the alignment degree is not limited, but is usually 0.99 or less.

The alignment degree of the specific organic coloring agent is measured according to the method described in the section of Examples later.

The alignment state of the specific organic coloring agent and the liquid crystal compound in the EO layer is preferably horizontal alignment or vertical alignment, and more preferably vertical alignment.

In the present specification, the “horizontal alignment” means that a main surface of the EO layer and a major axis direction of the specific organic coloring agent or the liquid crystal compound are parallel to each other. It is not required for both the main surface of the EO layer and the major axis direction of the liquid crystal compound to be strictly parallel; and in the present specification, the “horizontal alignment” means that both the main surface of the EO layer and the major axis direction of the specific organic coloring agent or the liquid crystal compound are aligned at an angle of 0° to 10°.

In addition, in the present specification, the “vertical alignment” means that a main surface of the EO layer and a major axis direction of the specific organic coloring agent or the liquid crystal compound are perpendicular to each other. It is not required for both the main surface of the EO layer and the major axis direction of the liquid crystal compound to be strictly perpendicular; and in the present specification, the “vertical alignment” means that both the main surface of the EO layer and the major axis direction of the specific organic coloring agent or the liquid crystal compound are aligned at an angle of 800 to 90°.

From the viewpoint of reducing the transmission loss, a surface roughness Ra of the EO layer is preferably 10 nm or less, more preferably 7 nm or less, and still more preferably 5 nm or less.

The lower limit of the surface roughness Ra of the EO layer is not particularly limited, but is preferably 0.5 nm or more.

The surface roughness Ra of the EO layer is measured according to the method described in the section of Examples later.

A thickness of the EO layer is preferably 0.3 to 5.0 m and more preferably 1.0 to 3.0 μm.

Here, the thickness of the EO layer is calculated as an average value of any five points measured using a surface roughness meter (for example, P-10 (manufactured by TENCOR)).

A method for forming the EO layer is not particularly limited, but from the viewpoint of further increasing the alignment degree of the liquid crystal compound and the specific organic coloring agent in the obtained EO layer, a method including a step of applying the above-described present composition onto an alignment layer to form a coating film (hereinafter, also referred to as “coating film forming step”) and a step of aligning the liquid crystal compound and the specific organic coloring agent contained in the coating film (hereinafter, also referred to as “alignment step”) in this order is exemplified.

### [Alignment Layer]

The alignment layer may be any layer as long as the specific organic coloring agent contained in the EO layer can be aligned in a desired alignment state.

Examples of a method for forming the alignment layer include methods such as rubbing treatment of a film surface of an organic compound (preferably a polymer), oblique vapor deposition of an inorganic compound, formation of a layer having microgrooves, and accumulation of an organic compound (for example, ω-tricosanoic acid, dioctadecylmethylammonium chloride, or methyl stearate) by the Langmuir-Blodgett method (LB film). Furthermore, an alignment layer in which an alignment function is generated by application of an electric field, application of a magnetic field, or light irradiation has been also known.

A thickness of the alignment layer is not particularly limited, but is preferably 0.01 to 2.0 μm and more preferably 0.01 to 1.0 μm.

Here, the thickness of the alignment layer is calculated as an average value of any five points measured using a surface roughness meter (for example, P-10 (manufactured by TENCOR)).

In the present invention, from the viewpoint of ease of controlling a pretilt angle of the alignment layer, an alignment layer formed by a rubbing treatment (rubbing-treated alignment layer) is preferable; and from the viewpoint of uniformity of alignment, a photo-alignment layer formed by light irradiation is preferable.

### <Rubbing-Treated Alignment Layer>

A polymer material used for the alignment layer formed by a rubbing treatment is described in a plurality of documents, and a plurality of commercially available products can be used. In the present invention, polyvinyl alcohol or polyimide, or derivatives thereof are preferably used. The alignment layer can refer to the description on page 43, line 24 to page 49, line 8 of WO2001/88574A1.

### <Photo-Alignment Layer>

A photo-alignment compound used for the alignment layer formed by irradiation with light is described in a plurality of documents. In the present invention, preferred examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; aromatic ester compounds described in JP2002-229039A; maleimide and/or alkenyl-substituted nadimide compounds having a photo-alignment unit, described in JP2002-265541A and JP2002-317013A; photo-crosslinkable silane derivatives described in JP4205195B and JP4205198B; and photo-crosslinkable polyimides, polyamides, or esters described in JP2003-520878A, JP2004-529220A, and JP4162850B. Azo compounds, photo-crosslinkable polyimides, polyamides, or esters are more preferable.

Among these, a photosensitive compound having a photo-aligned group, which undergoes at least one of dimerization or isomerization by action of light is preferably used as the photo-alignment compound.

In addition, examples of the photo-aligned group include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamoyl structure or a group having a coumarin structure is preferable, and a group having a cinnamoyl structure is more preferable.

In addition, the photosensitive compound having the above-described photo-aligned group may further have a crosslinkable group.

As the crosslinkable group, a thermally crosslinking group which causes a curing reaction due to action of heat or a photo-crosslinkable group which causes a curing reaction due to action of light is preferable, and the crosslinkable group may be a crosslinkable group which has both the thermally crosslinking group and the photo-crosslinkable group.

Examples of the above-described crosslinkable group include at least one selected from the group consisting of an epoxy group, an oxetanyl group, a group represented by —NH—CH₂—O—R (R represents a hydrogen atom or an alkyl group having 1 to 20 carbon atoms), a group having an ethylenically unsaturated double bond, and a blocked isocyanate group. Among these, an epoxy group, an oxetanyl group, or a group having an ethylenically unsaturated double bond is preferable.

A 3-membered cyclic ether group is also referred to as the epoxy group, and a 4-membered cyclic ether group is also referred to as the oxetanyl group.

In addition, specific examples of the group having an ethylenically unsaturated double bond include a vinyl group, an allyl group, a styryl group, an acryloyl group, and a methacryloyl group, and an acryloyl group or a methacryloyl group is preferable.

The photoalignment layer is produced by subjecting the photoalignment layer formed of the above-described material to irradiation with linearly polarized light or non-polarized light.

In the present specification, the “irradiation with linearly polarized light” and the “irradiation with non-polarized light” are operations for causing a photo-reaction in the photo-alignment material. A wavelength of the light to be used varies depending on the photo-alignment material to be used, and is not particularly limited as long as the wavelength is required for the photo-reaction. A peak wavelength of the light to be used for irradiation with light is preferably 200 nm to 700 nm, and ultraviolet light having a peak wavelength of 400 nm or less is more preferable.

Examples of a light source used for the light irradiation include commonly used light sources, for example, lamps such as a tungsten lamp, a halogen lamp, a xenon lamp, a xenon flash lamp, a mercury lamp, a mercury xenon lamp, or a carbon arc lamp, various lasers [such as a semiconductor laser, a helium neon laser, an argon ion laser, a helium cadmium laser, and a yttrium aluminum garnet (YAG) laser], a light emitting diode, and a cathode ray tube.

As a method of obtaining the linearly polarized light, a method of using a polarizing plate (for example, iodine polarizing plate, dichroic coloring agent polarizing plate, and wire grid polarizing plate), a method of using a prismatic element (for example, Glan-Thomson prism) or a reflective type polarizer using Brewster's angle, or a method of using light emitted from a polarized laser light source can be adopted. In addition, by using a filter, a wavelength conversion element, or the like, only light having a required wavelength may be radiated selectively.

In a case where light to be applied is the linearly polarized light, a method of applying light vertically or obliquely to the upper surface of the alignment layer or the surface of the alignment layer from the rear surface is employed. An incidence angle of light varies depending on the photo-alignment material, but is preferably 0° to 900 (vertical) and preferably 40° to 90°.

In a case where the light to be applied is the non-polarized light, the alignment layer is irradiated with the non-polarized light obliquely. An incidence angle is preferably 10° to 80°, more preferably 20° to 60°, and particularly preferably 30° to 50°.

The irradiation time is preferably 1 minute to 60 minutes and more preferably 1 minute to 10 minutes.

In a case where patterning is required, a method of performing irradiation with light using a photo mask as many times as necessary for pattern preparation or a method of writing a pattern by laser light scanning can be employed.

### [Coating Film Forming Step]

The coating film forming step is a step of applying the above-described present composition to form a coating film.

The photo-alignment layer is easily coated with the present composition by using the present composition containing the above-described solvent or using a liquid-like material such as a melt, which is obtained by heating the present composition.

Specific examples of a method of applying the present composition include known methods such as a roll coating method, a gravure printing method, a spin coating method, a wire bar coating method, an extrusion coating method, a direct gravure coating method, a reverse gravure coating method, a die-coating method, a spraying method, and an inkjet method.

### [Alignment Step]

The alignment step is a step of aligning the specific organic coloring agent and the liquid crystal compound contained in the coating film. As a result, the EO layer is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the specific organic coloring agent and the liquid crystal compound contained in the present composition may be aligned by the above-described coating film forming step or the drying treatment. For example, in an aspect in which the present composition is prepared as a coating liquid containing a solvent, the EO layer is obtained by drying the coating film to remove the solvent from the coating film.

It is preferable that the alignment step includes a heat treatment. As a result, the specific organic coloring agent and the liquid crystal compound contained in the coating film can be aligned, so that the coating film after the heating treatment can be suitably used as the EO layer.

From the viewpoint of manufacturing suitability or the like, the heat treatment is performed at a temperature of preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). As a result, the alignment of the specific organic coloring agent and the liquid crystal compound included in the coating film can be fixed. A cooling unit is not particularly limited, and the cooling treatment can be performed according to a known method.

### [Other Steps]

The method for forming the EO layer may include a step of curing the EO layer (hereinafter, also referred to as “curing step”) after the above-described alignment step. The curing step is performed by, for example, heating and/or performing light irradiation (exposure) in a case where the component contained in the EO layer (or the present composition) has a crosslinkable group (polymerizable group). Among these, it is preferable that the curing step is performed by irradiating the EO layer with light.

In addition, the method for forming the EO layer may include a step of performing a poling treatment after the above-described alignment step (or the above-described curing step).

Here, the poling treatment is not particularly limited, and known poling treatments such as a light poling method and an electric field poling method can be adopted. Among these, the electric field poling method is particularly preferable from the viewpoint of simplicity of a device, an alignment degree to be obtained, and the like.

The above-described electric field poling method is roughly classified into a contact poling method of sandwiching a nonlinear optical material between a pair of electrodes and applying an electric field, and a corona poling method of performing corona discharge on a surface of a nonlinear optical material on a substrate electrode and applying a charging electric field.

### [Laminate]

The laminate according to the embodiment of the present invention includes an alignment layer and an EO layer disposed on the alignment layer, and a base material may be disposed on a surface of the alignment layer opposite to the EO layer.

Hereinafter, each member constituting the laminate according to the embodiment of the present invention will be described.

### [Base Material]

The base material is not particularly limited, and for example, a resin substrate, a semiconductor substrate, an inorganic substrate (for example, a glass substrate), a metal substrate, or the like can be used; and a conductive film may be formed on a surface of these substrates.

### [Electro-Optical Layer]

Since the EO layer is as described above, the description thereof will not be repeated.

### [Alignment Layer]

Since the alignment layer is as described above, the description thereof will not be repeated.

### [Applications]

The laminate according to the embodiment of the present invention can be used as an optical element. Specific examples of the optical element include a wavelength conversion element, a photorefractive element, and an electro-optical element. Among these, it is preferable to be used in an electro-optical element such as an optical switch, an optical modulator, and a phase shifter, which operates based on an electro-optical effect.

### EXAMPLES

Hereinafter, the present invention will be described in more detail with reference to Examples. Materials, used amounts, ratios, treatment contents, treatment procedures, and the like described in Examples can be appropriately changed without departing from the spirit of the present invention. Therefore, the scope of the present invention should not be construed as being limited to Examples.

### Example 1

### <Formation of Alignment Layer>

The following alignment layer composition 1 was applied onto a glass substrate on which ITO was sputtered by spin coating, and dried at 100° C. for 1 minute to form an alignment layer 1 having a thickness of 0.5 μm.

Composition 1 for forming alignment layer

| | |
|---|---|
| Polyvinyl alcohol (POVALOL 3-88; | 2.1 parts by mass |
| manufactured by Kuraray Co., Ltd.) | |
| Methanol | 44.4 parts by mass |
| Distilled water | 53.5 parts by mass |

### <Formation of EO Layer 1>

The following composition 1 for forming an electro-optical layer was applied onto the alignment layer 1 by spin coating, and aged at 130° C. for 30 seconds to form an EO layer 1 (thickness: 1.8 μm) in which a liquid crystal compound L1 and an organic coloring agent E1 were vertically aligned. In this manner, a laminate 1 in which the glass substrate, the alignment layer, and the EO layer 1 were arranged in this order was obtained.

Composition 1 for forming electro-optical layer

| | |
|---|---|
| Liquid crystal compound L1 shown below | 0.0917 parts by mass |
| Organic coloring agent E1 shown below | 0.0100 parts by mass |
| Surfactant S1 shown below | 0.0010 parts by mass |
| Chloroform | 0.8973 parts by mass |

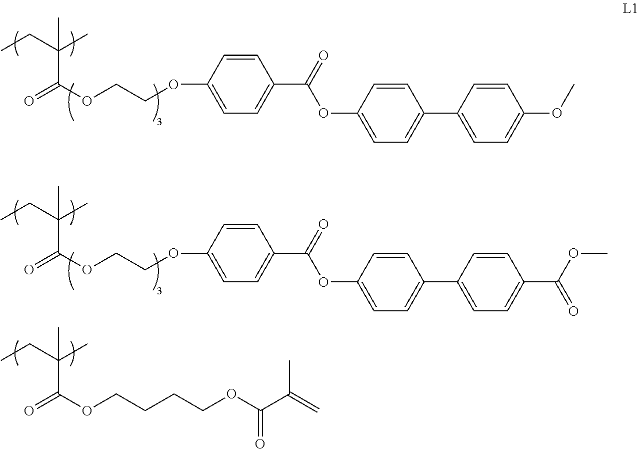

In the liquid crystal compound L1, a mass ratio of each constitutional unit from the left was 72.0:18.0:10.0, and a weight-average molecular weight was 18,000.

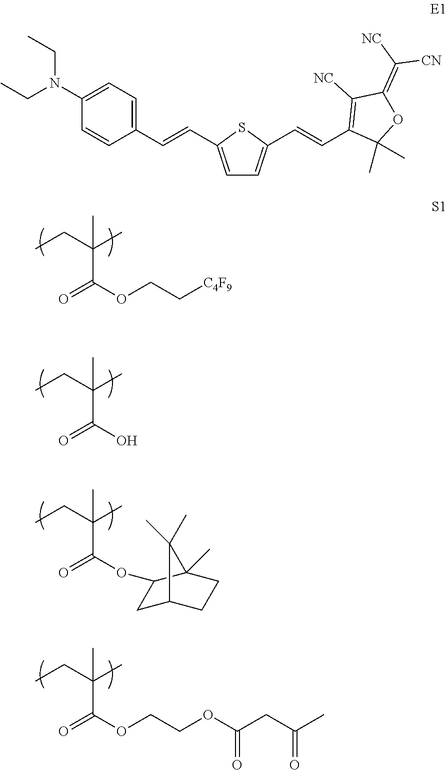

In the surfactant Si, a mass ratio of each constitutional unit from the left was 32.0:13.0:15.0:40.0, and a weight-average molecular weight was 16,000.

The obtained laminate 1 was placed on a hot plate, and subjected to a corona poling treatment. Specifically, the laminate 1 was held at 130° C. for 10 minutes in a state in which a charging voltage of 6 kV was applied to the EO layer 1 at an interval of 10 mm, the laminate 1 was air-cooled while applying the charging voltage from this state, and cooled to 23° C. over 10 minutes, and then the charging voltage was removed.

### Examples 2 to 8 and Comparative Examples 1 and 2

Laminates of each of Examples and Comparative Examples were obtained in the same manner as in Example 1, except that a composition for forming an electro-optical layer, having the formulation shown in Table 1, was used instead of the composition 1 for forming an electro-optical layer.

Structures of each component shown in Table 1 are shown below.

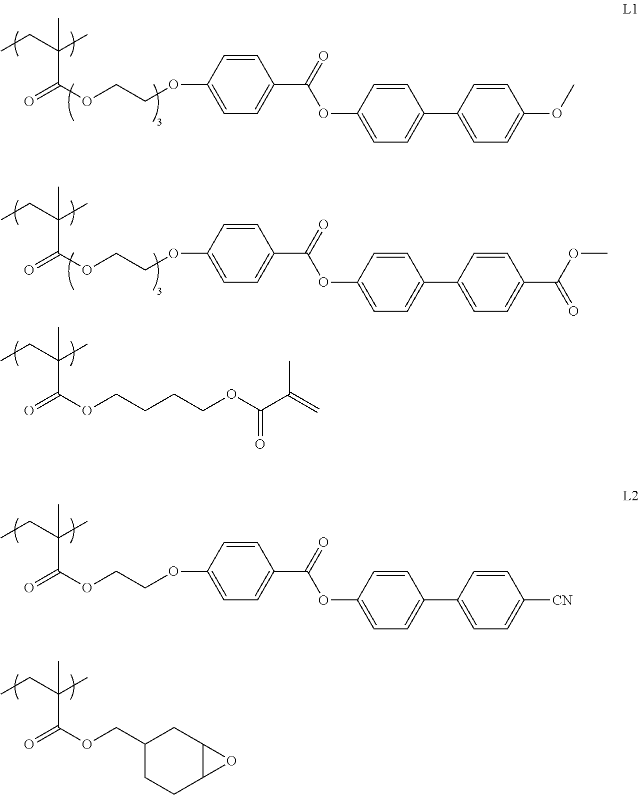

In the liquid crystal compound L1, a mass ratio of each constitutional unit from the left was 72.0:18.0:10.0, and a weight-average molecular weight was 18,000.

In the liquid crystal compound L2, a mass ratio of each constitutional unit from the left was 75.0:25.0, and a weight-average molecular weight was 25,000.

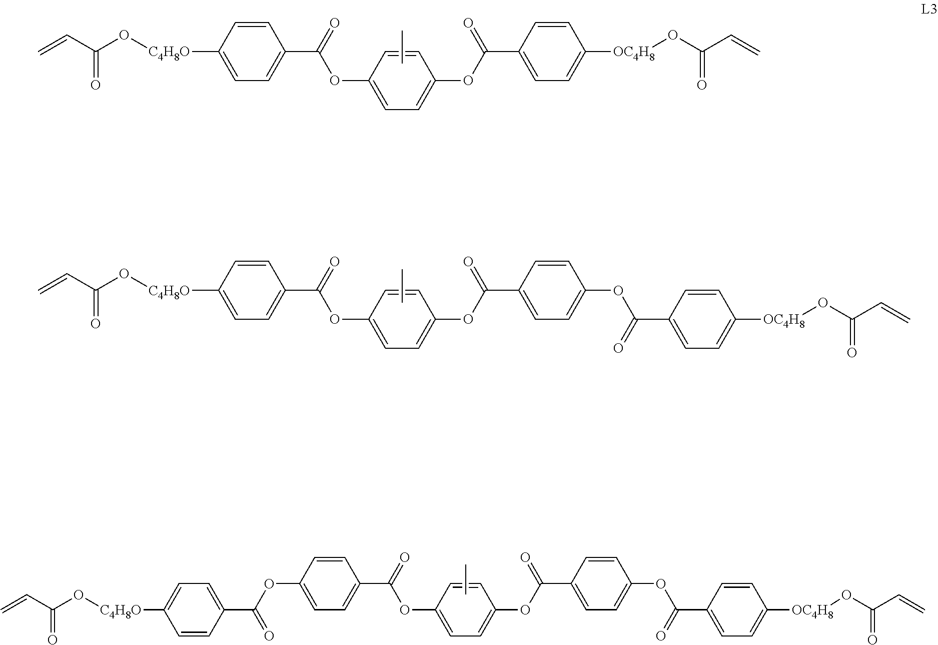

The liquid crystal compound L3 was a mixture of three low-molecular-weight liquid crystal compounds, and a mixing ratio (mass ratio) of each compound from the top was 82.0:15.0:3.0.

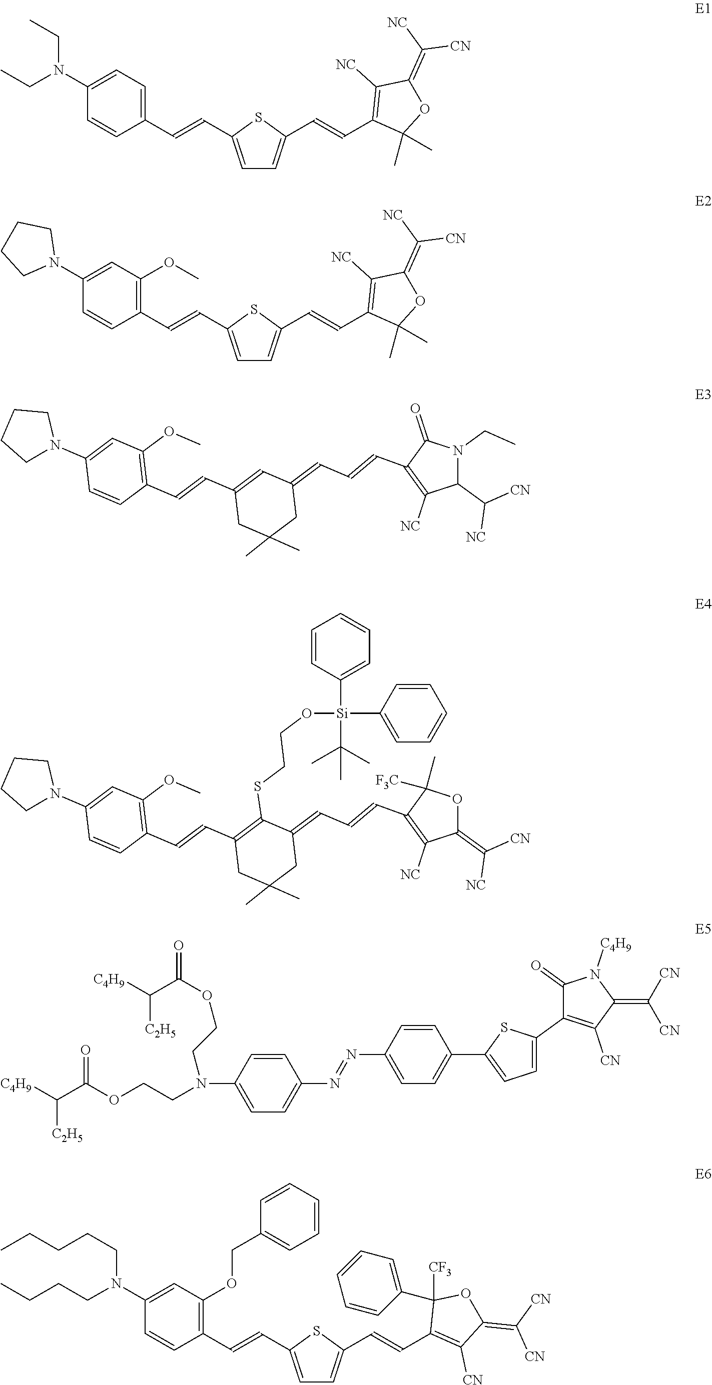

A second-order molecular susceptibility, a L/D ratio (aspect ratio), and θeg of each organic coloring agent were measured by the above-described methods. The results are shown in Table 1 later.

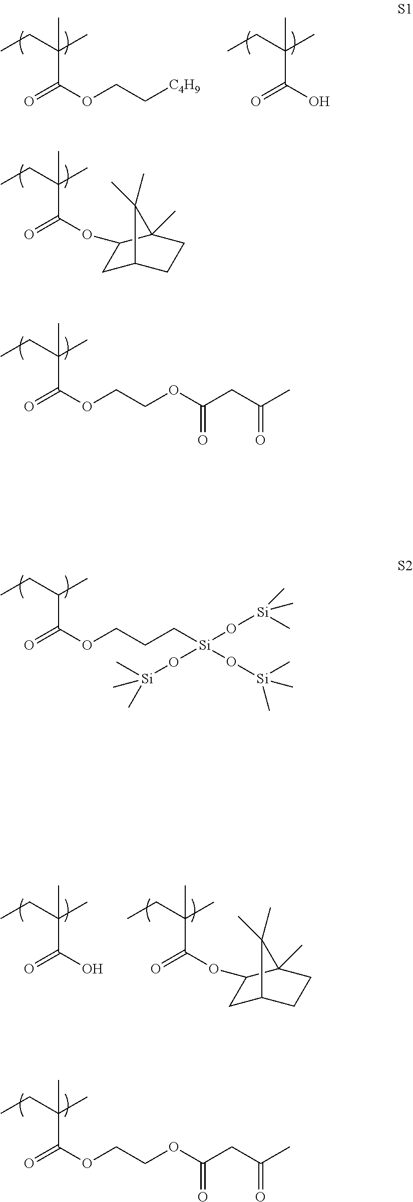

In the surfactant Si, a mass ratio of each constitutional unit from the left was 32.0:13.0:15.0:40.0, and a weight-average molecular weight was 16,000.

In the surfactant S2, a mass ratio of each constitutional unit from the left was 37.0:12.0:13.0:38.0, and a weight-average molecular weight was 18,000.

### Example 9

A laminate of Example 9 was obtained in the same manner as in Example 2, except that an alignment layer 2 produced as described below was used instead of the alignment layer 1.

### <Formation of Alignment Film>

The following alignment layer composition 2 was applied onto a glass substrate on which ITO was sputtered by spin coating, dried at 100° C. for 1 minute, and irradiated with non-polarized ultraviolet rays (10 mJ/cm², using an ultra-high pressure mercury lamp) from directly above the coating layer to form an alignment layer 2 having a thickness of 0.5 m.

Composition 2 for forming alignment layer

| | |
|---|---|
| Polymer PA1 shown below | 100.00 parts by mass |
| Acid generator PAG-1 shown below | 8.00 parts by mass |
| Acid generator CPI-110TF shown below | 0.005 parts by mass |
| Xylene | 1220.00 parts by mass |
| Methyl isobutyl ketone | 122.00 parts by mass |

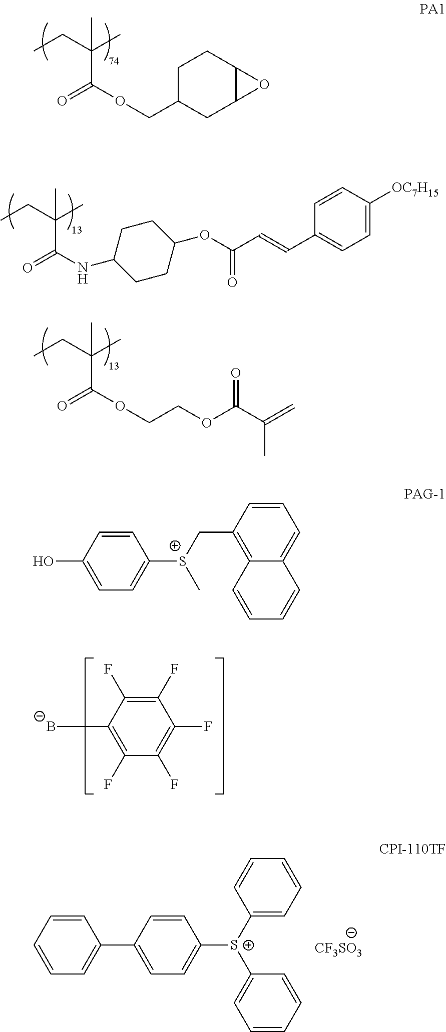

A weight-average molecular weight of the polymer PA1 was 19,000.

### [Evaluation]

### <Alignment Degree>

An alignment degree of the organic coloring agent was calculated by the following procedure.

In a state in which a linear polarizer was inserted on a light source side of an optical microscope (for example, a product “ECLIPSE E600 POL” manufactured by Nikon Corporation), the laminate of Example or Comparative Example was set on a sample stage, an absorbance of the electro-optical layer in a wavelength range of 380 nm to 780 nm was measured at a pitch of 1 nm using a multi-channel spectrometer (Ocean Optics, Inc., product name “QE65000”), and an alignment degree in a wavelength range of 400 nm to 700 nm was calculated by the following expression.

Alignment degree:S=((Az0/Ay0)−1)/((Az0/Ay0)+2)

In the above-described expression, “Az0” represents an absorbance of the electro-optical layer with respect to polarization in an absorption axis direction, and “Ay0” represents an absorbance of the electro-optical layer with respect to polarization in a transmission axis direction.

<Electro-Optical Coefficient (r0)>

The laminate subjected to the above-described corona poling treatment was measured for dependence of a change in refractive index at a wavelength of 1309 nm on the applied voltage using a prism coupler device (MODEL 2010/M manufactured by METRICON CORPORATION) and a coated prism (P-200C, a prism coated with nickel on a prism surface), and an electro-optical coefficient (hereinafter, also referred to as “r value”) was calculated and defined as r0.

The value of the electro-optical coefficient was evaluated according to the following standard based on the value of r0. The results are shown in Table 1.

The r value was calculated by the following expression (R). In the expression (R), δn/δV represents a slope of the dependence of the change in refractive index on the applied voltage, d represents a thickness (pm) of the laminate, and n™ represents a refractive index of the laminate (the laminate after the corona poling treatment) not applied with a voltage in a case where a TM wave was incident.

r={(δn/δV)×2×d}/(n_{TM}³) Expression (R)

(Evaluation standard)
S: 100 pm/V or more
A: 80 pm/V or more and less than 100 pm/V
B: 45 pm/V or more and less than 80 pm/V
C: 25 pm/V or more and less than 45 pm/V
D: 10 pm/V or more and less than 25 pm/V
E: less than 10 pm/V
   <Temporal Change of Electro-Optical Coefficient (r1/r0)>

In order to examine a temporal change of the electro-optical coefficient, the following evaluation was performed.

The laminate subjected to the above-described corona poling treatment was left at room temperature (23° C.) for 1 day, and the r value was obtained in the same manner as in the calculation of r0, and defined as r1.

The temporal change of the electro-optical coefficient was evaluated according to the following standard based on a ratio (r1/r0) of r1 to r0. The results are shown in Table 1.

### (Evaluation Standard)

A: 0.8 or more
B: less than 0.8

### <Unevenness>

The surface of the EO layer in the laminate subjected to the above-described corona poling treatment was observed at any three locations in an area of 620 μm×465 μm at a resolution of 640×480 pixels using BARTSCAN 2.0 (model number: R5300H) manufactured by Ryoka Systems Inc., and a surface roughness Ra of the three locations was measured. Surface unevenness of the surface of the EO layer was evaluated based on the arithmetic average value of the surface roughness Ra of the three locations. The results are shown in Table 1. As the value of Ra is smaller, the surface unevenness of the EO layer is small, and thus it can be said that the transmission loss due to the EO layer is small.

### (Evaluation Standard)

A: arithmetic average value of Ra was 10 nm or less.
B: arithmetic average value of Ra was more than 10 nm.

TABLE 1

| | | | | Organic coloring agent | | | | | | | | | | | |
|---|---|---|---|---|---|---|---|---|---|---|---|---|---|---|---|
| | | | | | | Second- | | | | | | | | | |
| | | | | | | order | | | | | | Align- | | | |
| | | | | | | molec- | | | | | | ment | | | |
| | | Liquid crystal | | | | ular | | | | | Chlo- | degree of | | | |
| | Align- | compound | | | | suscep- | | | Surfactant | | roform | organic | | | |
| | ment | | Part by | | Part by | tibility | L/D | θeg | | Part by | part by | coloring | | | Un- |
| | layer | Type | mass | Type | mass | 10⁻³³ esu | ratio | ° | Type | mass | mass | agent | r0 | r1/r0 | evenness |
| Example 1 | Alignment | L1 | 0.0917 | E1 | 0.0100 | 1619138 | 2.30 | 9.2 | S1 | 0.0010 | 0.8973 | 0.47 | C | A | A |
| | layer 1 | | | | | | | | | | | | | | |
| Example 2 | Alignment | L1 | 0.0918 | E2 | 0.0090 | 2768669 | 2.22 | 2.4 | S1 | 0.0010 | 0.8982 | 0.51 | B | A | A |
| | layer 1 | | | | | | | | | | | | | | |
| Example 3 | Alignment | L1 | 0.0920 | E3 | 0.0075 | 4912879 | 2.23 | 3.3 | S2 | 0.0010 | 0.8996 | 0.51 | A | A | A |
| | layer 1 | | | | | | | | | | | | | | |
| Example 4 | Alignment | L1 | 0.0918 | E4 | 0.0090 | 3208425 | 1.62 | 8.8 | S1 | 0.0010 | 0.8982 | 0.21 | C | A | A |
| | layer 1 | | | | | | | | | | | | | | |
| Example 5 | Alignment | L1 | 0.0850 | E5 | 0.0137 | 1172963 | 2.08 | 11.9 | S1 | 0.0008 | 0.9005 | 0.29 | C | A | A |
| | layer 1 | | | | | | | | | | | | | | |
| Example 6 | Alignment | L1 | 0.0920 | E6 | 0.0070 | 2851496 | 1.71 | 11.6 | S1 | 0.0010 | 0.9000 | 0.20 | D | A | A |
| | layer 1 | | | | | | | | | | | | | | |
| Example 7 | Alignment | L3 | 0.0917 | E2 | 0.0100 | 2768669 | 2.22 | 2.4 | S1 | 0.0010 | 0.8973 | 0.32 | B | A | A |
| | layer 1 | | | | | | | | | | | | | | |
| Example 8 | Alignment | L2 | 0.0816 | E3 | 0.0111 | 4912879 | 2.23 | 3.3 | S2 | 0.0010 | 0.9063 | 0.42 | S | A | A |
| | layer 1 | | | | | | | | | | | | | | |
| Example 9 | Alignment | L1 | 0.0918 | E2 | 0.0090 | 2768669 | 2.22 | 2.4 | S1 | 0.0010 | 0.8982 | 0.51 | B | A | A |
| | layer 2 | | | | | | | | | | | | | | |
| Comparative | Alignment | L1 | 0.0920 | E7 | 0.0070 | 348768 | 2.06 | 10.8 | — | 0.0000 | 0.9000 | 0.32 | E | A | B |
| Example 1 | layer 1 | | | | | | | | | | | | | | |
| Comparative | Alignment | L1 | 0.0921 | E2 | 0.0070 | 2768669 | 2.22 | 2.4 | — | 0.0000 | 0.9009 | 0.39 | C | A | B |
| Example 2 | layer 1 | | | | | | | | | | | | | | |

As shown in Table 1, in a case where the present composition was used, it was possible to form an EO layer having a high electro-optical coefficient, and it can be said that the transmission loss was small since the surface unevenness of the EO layer was small (Examples).

From the comparison between Examples 1 to 9, it was found that the alignment degree of the organic coloring agent was more excellent in a case where the aspect ratio of the molecule of the organic coloring agent was 2.0 or more and/or θeg was 10.0° or less (Examples 1 to 5 and Examples 7 to 9). Among these, it was found that the alignment degree of the organic coloring agent was particularly excellent in a case where both the aspect ratio of the molecule of the organic coloring agent was 2.0 or more and θeg was 10.0° or less (Examples 1 to 3 and Examples 7 to 9).

On the other hand, in a case where a composition containing no surfactant and containing an organic coloring agent having a second-order molecular susceptibility of less than 400000×10⁻³³ esu was used, it can be said that an EO layer having a low electro-optical coefficient was formed, and the transmission loss was large since the surface unevenness of the EO layer was large (Comparative Example 1).

In addition, in a case where a composition containing no surfactant was used, it can be said that the transmission loss was large since the surface unevenness of the EO layer was large (Comparative Example 2).

What is claimed is:

1. A composition for forming an electro-optical layer, comprising:
a liquid crystal compound;
an organic coloring agent having a second-order molecular susceptibility of 400000×10⁻³³ esu or more; and
a surfactant.

2. The composition for forming an electro-optical layer according to claim 1,
wherein an aspect ratio of a molecule of the organic coloring agent is 2.0 or more.

3. The composition for forming an electro-optical layer according to claim 1,
wherein an angle θeg formed by a vector of a molecular major axis and a vector of a transition dipole moment in the organic coloring agent is 10.0° or less.

4. The composition for forming an electro-optical layer according to claim 1,
wherein the organic coloring agent is a compound represented by Formula (E1), 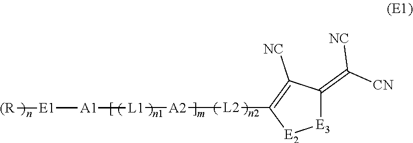
in Formula (E1),
R represents a hydrogen atom, or an alkyl group, an aryl group, or a heterocyclic group, which may have a substituent, in which —CH₂— in the alkyl group may be substituted with a divalent substituent, and in a case where n is 2 or more, two or more R's may be the same or different from each other, and may be bonded to each other to form a ring including E1,
E1 represents an oxygen atom, a sulfur atom, or a nitrogen atom,
A1 represents —C(R^{A1})═C(R^{A2})—, or an arylene group or a heterocyclic group, which may have a substituent,
R^{A1} and R^{A2} each independently represent a hydrogen atom, —SH, or an alkyl group, in which —CH₂— in the alkyl group may be substituted with a divalent substituent, and in a case where A1 is —C(R^{A1})═C(R^{A2})—, R^{A1} and R may be bonded to each other to form a ring including E1,
A2 represents a single bond, or an arylene group or a heterocyclic group, which may have a substituent, in which, in a case where m is 2 or more, two or more A2's may be the same or different from each other,
L1 and L2 each independently represent a single bond, —C(R^{L1})═C(R^{L2})—, —N═C(R^{L4})—, —C(R^{L4})═N—, —C≡C—, or —N═N—, in which, in a case where n1 or m is 2 or more, two or more L1's may be the same or different from each other, in a case where n2 is 2 or more, two or more L2's may be the same or different from each other, in a case where n1 is 2 or more, adjacent L1's may be bonded to each other to form a ring, in a case where n2 is 2 or more, adjacent L2's may be bonded to each other to form a ring, and in a case where L1 and L2 are adjacent to each other, adjacent L1 and L2 may be bonded to each other to form a ring,
R^{L1}, R^{L2}, and R^{L4} each independently represent a hydrogen atom, a halogen atom, a cyano group, a nitro group, a hydroxy group, a thiol group, an alkyl group having 1 to 15 carbon atoms, an aryl group having 6 to 20 carbon atoms, —O—Si(R^{L5})₃, or a group formed by combining two or more of these groups, in which —CH₂— in the alkyl group may be substituted with a divalent substituent, and a plurality of R^{L5}'s each independently represent a hydrogen atom, an alkyl group, or a phenyl group,
E₂ represents —C(R^{E21})(R^{E22})—, —C(═O)—, —C(═S)—, or —C(═NR^{E4})—,
R^{E21} and R^{E22} each independently represent a hydrogen atom, a halogen atom, an alkyl group having 1 to 15 carbon atoms, a fluoroalkyl group having 1 to 8 carbon atoms, an aryl group having 1 to 20 carbon atoms, a cyano group, or a nitro group, in which —CH₂— in the alkyl group may be substituted with a divalent substituent, and hydrogen atoms of the alkyl group and the aryl group may be substituted with a monovalent substituent,
R^{E4} represents a hydrogen atom or an alkyl group having 1 to 15 carbon atoms, in which —CH₂— in the alkyl group may be substituted with a divalent substituent,
E₃ represents —O—, —S—, —N(R^{E5})—, or —S(═O)—,
R^{E5} represents a hydrogen atom, or an alkyl group having 1 to 15 carbon atoms, an aryl group having 5 to 20 carbon atoms, an alkylcarbonyl group having 1 to 15 carbon atoms, an arylcarbonyl group having 5 to 20 carbon atoms, an alkylsulfonyl group having 1 to 15 carbon atoms, or an arylsulfonyl group having 5 to 20 carbon atoms, which may have a substituent,
n represents an integer of 1 or 2,
n1 represents an integer of 0 to 3,
n2 represents an integer of 0 to 3, and
m represents an integer of 0 to 4.

5. An electro-optical layer formed of the composition for forming an electro-optical layer according to claim 1,
wherein the organic coloring agent contained in the electro-optical layer is aligned.

6. The electro-optical layer according to claim 5,
wherein an alignment degree of the organic coloring agent is more than 0.3.

7. A laminate comprising:
an alignment layer; and
the electro-optical layer according to claim 5, which is disposed on the alignment layer.

8. The composition for forming an electro-optical layer according to claim 2,
wherein an angle θeg formed by a vector of a molecular major axis and a vector of a transition dipole moment in the organic coloring agent is 10.0° or less.

9. The composition for forming an electro-optical layer according to claim 2,
wherein the organic coloring agent is a compound represented by Formula (E1), 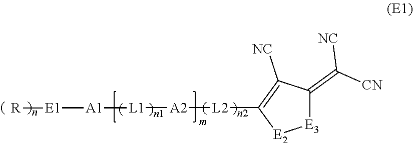
in Formula (E1),
R represents a hydrogen atom, or an alkyl group, an aryl group, or a heterocyclic group, which may have a substituent, in which —CH₂— in the alkyl group may be substituted with a divalent substituent, and in a case where n is 2 or more, two or more R's may be the same or different from each other, and may be bonded to each other to form a ring including E1,
E1 represents an oxygen atom, a sulfur atom, or a nitrogen atom,
A1 represents —C(R^{A1})═C(R^{A2})—, or an arylene group or a heterocyclic group, which may have a substituent,
R^{A1} and R^{A2} each independently represent a hydrogen atom, —SH, or an alkyl group, in which —CH₂— in the alkyl group may be substituted with a divalent substituent, and in a case where A1 is —C(R^{A1})═C(R^{A2})—, R^{A1} and R may be bonded to each other to form a ring including E1,
A2 represents a single bond, or an arylene group or a heterocyclic group, which may have a substituent, in which, in a case where m is 2 or more, two or more A2's may be the same or different from each other,
L1 and L2 each independently represent a single bond, —C(R^{L1})═C(R^{L2})—, —N═C(R^{L4})—, —C(R^{L4})═N—, —C≡C—, or —N═N—, in which, in a case where n1 or m is 2 or more, two or more L1's may be the same or different from each other, in a case where n2 is 2 or more, two or more L2's may be the same or different from each other, in a case where n1 is 2 or more, adjacent L1's may be bonded to each other to form a ring, in a case where n2 is 2 or more, adjacent L2's may be bonded to each other to form a ring, and in a case where L1 and L2 are adjacent to each other, adjacent L1 and L2 may be bonded to each other to form a ring,
R^{L1}, R^{L2}, and R^{L4} each independently represent a hydrogen atom, a halogen atom, a cyano group, a nitro group, a hydroxy group, a thiol group, an alkyl group having 1 to 15 carbon atoms, an aryl group having 6 to 20 carbon atoms, —O—Si(R^{L5})₃, or a group formed by combining two or more of these groups, in which —CH₂— in the alkyl group may be substituted with a divalent substituent, and a plurality of R^{L5}'s each independently represent a hydrogen atom, an alkyl group, or a phenyl group,
E₂ represents —C(R^{E21})(R^{E22})—, —C(═O)—, —C(═S)—, or —C(═NR^{E4})—,
R^{E21} and R^{E22} each independently represent a hydrogen atom, a halogen atom, an alkyl group having 1 to 15 carbon atoms, a fluoroalkyl group having 1 to 8 carbon atoms, an aryl group having 1 to 20 carbon atoms, a cyano group, or a nitro group, in which —CH₂— in the alkyl group may be substituted with a divalent substituent, and hydrogen atoms of the alkyl group and the aryl group may be substituted with a monovalent substituent,
R^{E4} represents a hydrogen atom or an alkyl group having 1 to 15 carbon atoms, in which —CH₂— in the alkyl group may be substituted with a divalent substituent,
E₃ represents —O—, —S—, —N(R^{E5})—, or —S(═O)—,
R^{E5} represents a hydrogen atom, or an alkyl group having 1 to 15 carbon atoms, an aryl group having 5 to 20 carbon atoms, an alkylcarbonyl group having 1 to 15 carbon atoms, an arylcarbonyl group having 5 to 20 carbon atoms, an alkylsulfonyl group having 1 to 15 carbon atoms, or an arylsulfonyl group having 5 to 20 carbon atoms, which may have a substituent,
n represents an integer of 1 or 2,
n1 represents an integer of 0 to 3,
n2 represents an integer of 0 to 3, and
m represents an integer of 0 to 4.

10. An electro-optical layer formed of the composition for forming an electro-optical layer according to claim 2,
wherein the organic coloring agent contained in the electro-optical layer is aligned.

11. The electro-optical layer according to claim 10,
wherein an alignment degree of the organic coloring agent is more than 0.3.

12. A laminate comprising:
an alignment layer; and
the electro-optical layer according to claim 10, which is disposed on the alignment layer.

13. The composition for forming an electro-optical layer according to claim 3,
wherein the organic coloring agent is a compound represented by Formula (E1), 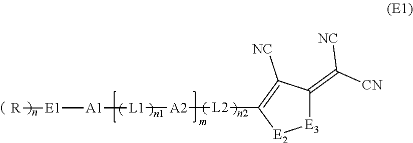
in Formula (E1),
R represents a hydrogen atom, or an alkyl group, an aryl group, or a heterocyclic group, which may have a substituent, in which —CH₂— in the alkyl group may be substituted with a divalent substituent, and in a case where n is 2 or more, two or more R's may be the same or different from each other, and may be bonded to each other to form a ring including E1,
E1 represents an oxygen atom, a sulfur atom, or a nitrogen atom,
A1 represents —C(R^{A1})═C(R^{A2})—, or an arylene group or a heterocyclic group, which may have a substituent,
R^{A1} and R^{A2} each independently represent a hydrogen atom, —SH, or an alkyl group, in which —CH₂— in the alkyl group may be substituted with a divalent substituent, and in a case where A1 is —C(R^{A1})═C(R^{A2})—, R^{A1} and R may be bonded to each other to form a ring including E1,
A2 represents a single bond, or an arylene group or a heterocyclic group, which may have a substituent, in which, in a case where m is 2 or more, two or more A2's may be the same or different from each other,
L1 and L2 each independently represent a single bond, —C(R^{L1})═C(R^{L2})—, —N═C(R^{L4})—, —C(R^{L4})═N—, —C≡C—, or —N═N—, in which, in a case where n1 or m is 2 or more, two or more L1's may be the same or different from each other, in a case where n2 is 2 or more, two or more L2's may be the same or different from each other, in a case where n1 is 2 or more, adjacent L1's may be bonded to each other to form a ring, in a case where n2 is 2 or more, adjacent L2's may be bonded to each other to form a ring, and in a case where L1 and L2 are adjacent to each other, adjacent L1 and L2 may be bonded to each other to form a ring,
R^{L1}, R^{L2}, and R^{L4} each independently represent a hydrogen atom, a halogen atom, a cyano group, a nitro group, a hydroxy group, a thiol group, an alkyl group having 1 to 15 carbon atoms, an aryl group having 6 to 20 carbon atoms, —O—Si(R^{L5})₃, or a group formed by combining two or more of these groups, in which —CH₂— in the alkyl group may be substituted with a divalent substituent, and a plurality of R^{L5}'s each independently represent a hydrogen atom, an alkyl group, or a phenyl group,
E₂ represents —C(R^{E21})(R^{E22})—, —C(═O)—, —C(═S)—, or —C(═NR^{E4})—,
R^{E21} and R^{E22} each independently represent a hydrogen atom, a halogen atom, an alkyl group having 1 to 15 carbon atoms, a fluoroalkyl group having 1 to 8 carbon atoms, an aryl group having 1 to 20 carbon atoms, a cyano group, or a nitro group, in which —CH₂— in the alkyl group may be substituted with a divalent substituent, and hydrogen atoms of the alkyl group and the aryl group may be substituted with a monovalent substituent,
R^{E4} represents a hydrogen atom or an alkyl group having 1 to 15 carbon atoms, in which —CH₂— in the alkyl group may be substituted with a divalent substituent,
E₃ represents —O—, —S—, —N(R^{E5})—, or —S(═O)—,
R^{E5} represents a hydrogen atom, or an alkyl group having 1 to 15 carbon atoms, an aryl group having 5 to 20 carbon atoms, an alkylcarbonyl group having 1 to 15 carbon atoms, an arylcarbonyl group having 5 to 20 carbon atoms, an alkylsulfonyl group having 1 to 15 carbon atoms, or an arylsulfonyl group having 5 to 20 carbon atoms, which may have a substituent,
n represents an integer of 1 or 2,
n1 represents an integer of 0 to 3,
n2 represents an integer of 0 to 3, and
m represents an integer of 0 to 4.

14. An electro-optical layer formed of the composition for forming an electro-optical layer according to claim 3,
wherein the organic coloring agent contained in the electro-optical layer is aligned.

15. The electro-optical layer according to claim 14,
wherein an alignment degree of the organic coloring agent is more than 0.3.

16. A laminate comprising:
an alignment layer; and
the electro-optical layer according to claim 14, which is disposed on the alignment layer.

17. An electro-optical layer formed of the composition for forming an electro-optical layer according to claim 4,
wherein the organic coloring agent contained in the electro-optical layer is aligned.

18. The electro-optical layer according to claim 17,
wherein an alignment degree of the organic coloring agent is more than 0.3.

19. A laminate comprising:
an alignment layer; and
the electro-optical layer according to claim 17, which is disposed on the alignment layer.
